(19) United States
(12) Patent Application Publication
(10) Pub. No.: US 2024/0083143 A1
(43) Pub. Date: Mar. 14, 2024

(54) SYSTEM AND PROCESS FOR FORMING CURVED GLASS LAMINATE ARTICLE USING SEPARATION MATERIAL

(71) Applicant: Corning Incorporated, Corning, NY (US)

(72) Inventors: Vikram Bhatia, Painted Post, NY (US); Mika Eronen, Oulu (FI); Anurag Jain, Painted Post, NY (US); Laurent Joubaud, Paris (FR); Louis Mattos, Jr., Painted Post, NY (US); SangKi Park, Painted Post, NY (US); Zheming Zheng, Horseheads, NY (US)

(21) Appl. No.: 17/766,813

(22) PCT Filed: Sep. 23, 2020
(86) PCT No.: PCT/US2020/052140

§ 371 Date: Apr. 6, 2022

Related U.S. Application Data
(60) Provisional application No. 62/923,363, filed on Oct. 18, 2019.

(51) Int. Cl. B32B 17/10

(52) U.S. Cl. CPC B32B 17/10036; B32B 17/10091; B32B 17/10119; B32B 17/10889; B32B 2307/40; B32B 2307/732; B32B 2605/00

(57) ABSTRACT

A co-shaped laminate is provided. The laminate includes a first curved glass substrate having a first major surface, a second major surface opposing the first major surface, a first thickness (h₁), and a first viscosity (η₁) of 1×10¹¹ poises at a first temperature (T1); a second curved glass substrate having a third major surface, a fourth major surface opposing the third major surface, a second thickness (h₂), the second thickness being less than the first thickness, and a second viscosity (η₂) at the first temperature (T1); and an interlayer disposed between the first curved glass substrate and the second curved glass substrate, wherein the ratio of the first thickness to the second thickness (h₁/h₂) is greater than about 2.1, and wherein the ratio of the second viscosity to the first viscosity (η₂/η₁) is between about (h₁/h₂)^{2.55} and about (h₁/h₂)^{3.45}.

### CROSS-REFERENCE TO RELATED APPLICATIONS

This application claims the benefit of priority under 35 U.S.C. § 119 of U.S. Provisional Application Ser. No. 62/923,363 filed on Oct. 18, 2019 the content of which is relied upon and incorporated herein by reference in its entirety.

### FIELD

The present disclosure relates generally to forming a curved glass laminate article, and more particularly to processes for co-forming (e.g., co-sagging) glass sheets utilizing glass sheets having properties that reduce formation of bending dots in the curved glass laminate article.

### BACKGROUND

Curved glass laminate sheets or articles find use in many applications, particularly as for vehicle or automotive window glass. Conventionally, curved glass sheets for such applications have been formed from relatively thick sheets of glass material. To improve shape consistency between individual glass layers of the laminate article, the glass materials may be shaped to the desired shape/curvature via a co-forming process, such as a co-sagging process. However, traditional co-sagging processes may produce undesirable characteristics (e.g., excessive bending dots) in the curved glass sheets, the severity of which has been conventionally believed to increase as the difference between the thicknesses and/or viscosities of the co-sagged pair of glass sheets increases.

### SUMMARY

According to an embodiment of the present disclosure, a laminate is provided. The laminate includes a first curved glass substrate comprising a first major surface, a second major surface opposing the first major surface, a first thickness (h₁) defined as the distance between the first major surface and second major surface, and a first viscosity (η₁) of 1×10¹¹ poises at a first temperature (T1); a second curved glass substrate comprising a third major surface, a fourth major surface opposing the third major surface, a second thickness (h₂) defined as the distance between the third major surface and the fourth major surface, the second thickness being less than the first thickness, and a second viscosity (η₂) at the first temperature (T1); and an interlayer disposed between the first curved glass substrate and the second curved glass substrate and adjacent the second major surface and third major surface, wherein the first curved glass substrate, the second curved glass substrate and the interlayer comprise a co-shaped stack, wherein the ratio of the first thickness to the second thickness (h₁/h₂) is greater than about 2.1, and wherein the ratio of the second viscosity to the first viscosity (η₂/η₁) is between about (h₁/h₂)^{2.55} and about (h₁/h₂)^{3.45}.

According to an embodiment of the present disclosure, a method of forming a curved laminate is provided. The method includes disposing separation media on a second major surface of a first glass substrate, the separation media being disposed in a predetermined pattern; forming a stack comprising the first glass substrate and a second glass substrate with the separation media disposed therebetween; and heating the stack and co-shaping the stack to form a co-shaped stack, the co-shaped stack comprising a first curved glass substrate having a first sag depth and a second curved glass substrate having a second sag depth, wherein the first glass substrate comprises a first major surface opposing the second major surface, a first thickness defined as the distance between the first major surface and second major surface, and a first viscosity (η₁) of 1×10¹¹ poises at a first temperature (T1), wherein the second glass substrate comprises a third major surface, a fourth major surface opposing the third major surface, a second thickness defined as the distance between the third major surface and the fourth major surface, the second thickness being less than the first thickness, and a second viscosity (η₂) at the first temperature (T1), wherein the ratio of the first viscosity to the second viscosity is approximately the cube of the ratio of the first thickness to the second thickness, wherein the ratio of the first thickness to the second thickness (h₁/h₂) is greater than about 2.1, and wherein the ratio of the second viscosity to the first viscosity (η₂/η₁) is between about (h₁/h₂)^{2 55} and about (h₁/h₂)^{3 45}

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The disclosure will be understood more clearly from the following description and from the accompanying figures, given purely by way of non-limiting example, in which:

FIG. 1 is a side view of shaped laminate according to embodiments of the present disclosure;

FIG. 1A is a side view of a shaped laminate according to embodiments of the present disclosure;

FIG. 2 is a side view of a glass substrates according to embodiments of the present disclosure;

FIG. 3 is a perspective view of a vehicle according to embodiments of the present disclosure;

FIG. 4 is a side cross-sectional view of a lehr furnace that can be used in a method for forming a curved laminate according to embodiments of the present disclosure;

FIG. 5 is a schematic cross-sectional view of a bending ring with glass plies and disposition of separation media according to embodiments of the present disclosure; and

FIGS. 6A-6D are graphs showing the degree of glass deformation across the surface of four separate hypothetical laminates.

### DETAILED DESCRIPTION

Reference will now be made in detail to the present embodiment(s), an example(s) of which is/are illustrated in the accompanying drawings. Whenever possible, the same reference numerals will be used throughout the drawings to refer to the same or like parts.

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

As used herein, “have,” “having,” “include,” “including,” “comprise,” “comprising” or the like are used in their open ended sense, and generally mean “including, but not limited to.”

All scientific and technical terms used herein have meanings commonly used in the art unless otherwise specified. The definitions provided herein are to facilitate understanding of certain terms used frequently herein and are not meant to limit the scope of the present disclosure.

The present disclosure is described below, at first generally, then in detail on the basis of several exemplary embodiments. The features shown in combination with one another in the individual exemplary embodiments do not all have to be realized. In particular, individual features may also be omitted or combined in some other way with other features shown of the same exemplary embodiment or else of other exemplary embodiments.

The terms “top”, “bottom”, “side”, “upper”, “lower”, “above”, “below” and the like are used herein for descriptive purposes and not necessarily for describing permanent relative positions. It should be understood that the terms so used are interchangeable under appropriate circumstances such that embodiments of the present disclosure are, for example, capable of operation in other orientations than those illustrated or otherwise described herein.

As used herein, the phrase “laminates,” which may also be referred to as “laminate structures,” laminate glass structures, or “glazings,” relates to a transparent, semitransparent, translucent or opaque glass-based material.

Embodiments of the present disclosure relate to laminates and vehicles and architectural panels that incorporate such structures. Laminates according to embodiments of the present disclosure include at least two glass substrates (i.e., a first glass substrate and a second glass substrate) that have different thicknesses. The first glass substrate may be thicker than the second glass substrate. Alternatively, the first glass substrate may be thinner than the second glass substrate. The laminate may be an automotive glazing in which the second glass substrate is exposed to a vehicle or automobile interior and the first glass substrate faces an outside environment of the automobile. As an alternative, the laminate may be an automotive glazing in which the first glass substrate is exposed to a vehicle or automobile interior and the second glass substrate faces an outside environment of the automobile. The laminate may be used in architectural applications in which the second glass substrate is exposed to a building, room, or furniture interior and the first glass substrate faces an outside environment of the building, room or furniture. As an alternative, the laminate may be used in architectural applications in which the first glass substrate is exposed to a building, room, or furniture interior and the second glass substrate faces an outside environment of the building, room or furniture. According the embodiments of the present disclosure, the first glass substrate and second glass substrate may be bonded together by an interlayer.

Laminates described herein include a surface of the glass substrate that forms the exterior facing surface of the laminate and is referred to as the first outer surface (sometimes referred to as surface one or S1), a surface of the glass substrate that opposes the first outer surface is referred to as the second inner surface (sometimes referred to as surface two or S2), a surface of the other glass substrate that is adjacent to the second inner surface is referred to as the third outer surface (sometimes referred to as surface three or S3), and the surface of the other glass substrate that opposes the third outer surface is referred to as the fourth inner surface (sometimes referred to as surface four or S4).

Embodiments of the present disclosure relate to various co-shaped, curved, glass laminate articles and to various systems and methods for shaping, bending or sagging a stack of glass sheets for formation of such curved, glass laminate articles. In general, conventional processes for forming curved, laminated glass articles involve hot forming processes which include heating a pair of stacked glass plates or sheets on a forming ring to near the softening temperature of the glass until the glass has sagged to the desired shape and depth. A separation material may be used as a separation layer between the two glass sheets preventing the glass sheets from being bonded or fused together during heating. While such hot forming and co-sagging processes have a variety of advantages, such as improving shape matching between the glass sheets that will form the laminate, efficient use of heating equipment, process throughput, etc., co-sagging often produces optical defects known in the industry as bending dots or bending dot defects.

This phenomenon of bending dot defects has been attributed to an increase in contact pressure between the glass plies. More specifically, the two plies do not soften at the same rate and/or shape and thus pressure is applied to the surfaces between the upper and lower glass plates, which can cause local deformations or indents, due to the presence of large particles from separation powder or other foreign particles between the two glass plates. If sagged individually, a thicker ply will produce a more parabolic shape during gravity sagging, while a thinner ply will produce a “bath tub” like shape where curvature is greatest near the edges and is reduced near the center. As a result, the contact pressure is increased near the edges when a thin ply is sagged on top of a thick ply. Likewise, contact pressure is increased near the center when a thick ply is sagged on top of a thin ply. This increase in contact pressure is thought to contribute to the creation of bending dot defects.

Embodiments of this disclosure pertain to co-shaped glass laminates that are thin or have a reduced weight compared to conventional laminates, while exhibiting superior strength and meeting regulatory requirements for use in automotive and architectural applications. Conventional laminates include two soda lime silicate glass substrates having a thickness in a range from about 1.6 mm to about 3 mm, where the thicknesses of the two glass substrates are substantially similar. For various reasons it may be advantageous for at least one of the soda lime silicate glass substrates to be replaced with a glass substrate having a different thickness and/or a different composition than the conventional soda lime silicate glass substrate. For example, to reduce the thickness of at least one of the glass substrates, while maintaining or improving the strength and other performance of the laminate, one of the glass substrates can include a strengthened glass substrate which tends to have very different viscosity as a function of temperature (or viscosity curve) than the soda lime silicate glass substrate. In particular, typical strengthened glass substrates exhibit a significantly higher viscosity at a given temperature than soda lime silicate glass substrates. It has also been determined that maintaining or improving the strength and other performance of laminates having glass substrates of the same composition (such as a soda lime composition), or glass substrates having different compositions that are also unstrengthened, may be achieved by providing highly asymmetric glass substrates, where a first of the glass substrates of the laminate is much thicker than a second of the glass substrates of the laminate.

It was previously believed that co-shaping, and in particular co-sagging, glass substrates differing in thickness and/or viscosity was not possible due to the increased contact pressure described above and/or difference in viscosity curves. However, as will be described herein, such successful co-shaping (including co-sagging) can be achieved to form a laminate that exhibits substantially minimal shape mismatch, minimal stress due to co-shaping, and low or substantially low optical distortion.

It was also generally understood that a glass substrate with lower viscosity (e.g., soda lime silicate glass substrate) could be co-sagged with a higher viscosity glass substrate by positing the lower viscosity glass substrate on top of the higher viscosity glass substrate. In particular, it was believed that the opposite configuration, the lower viscosity glass substrate would sag to a deeper depth than the higher viscosity glass substrate. Surprisingly, as will be described herein, successful co-sagging can be achieved with this opposite configuration—that is, the higher viscosity glass substrate is placed on top of the lower viscosity glass substrate. Such co-sagged glass substrates exhibit substantially identical shapes, while achieving a deep or large sag depth, and can be laminated together with an interlayer between the glass substrates to form a shaped laminate exhibiting minimal optical and stress defects.

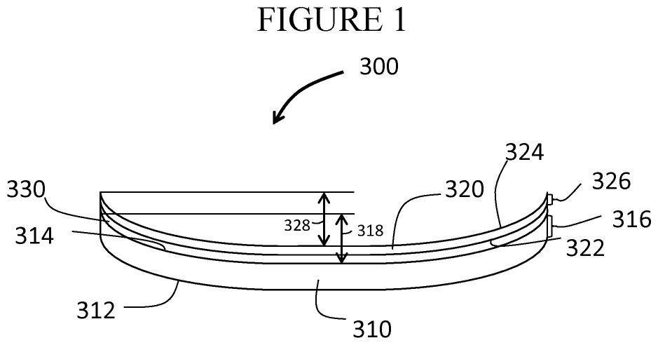

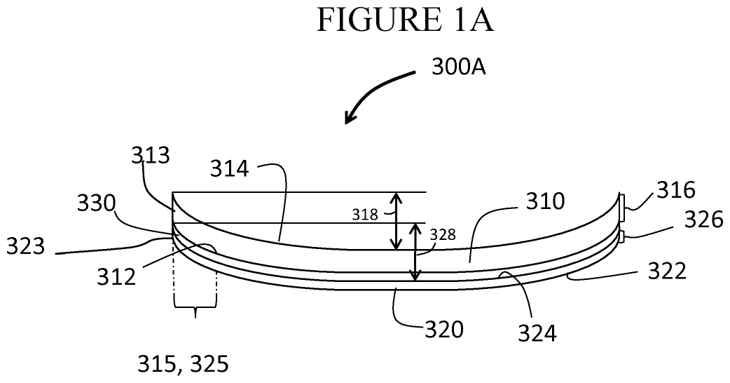

As used herein, the phrase “sag depth” refers to the maximum distance between two points on the same convex surface of a curved glass substrate, as illustrated in FIG. 1 by reference characters “318” and “328”. As illustrated in FIG. 1, the point on the convex surface at the edge and the point on the convex surface at or near the center of the convex surface provide the maximum distance 318 and 328.

It has been determined that traditional co-sagging can lead to formation of an undesirable level of bending dots, particularly when co-sagging is used with two glass sheets having significantly different thicknesses and/or different material properties, such as viscosity. In general, bending dot formation is believed to increase as the contact pressure between the two glass sheets is increased during co-sagging. This increased contact pressure during co-sagging may be a function of viscosity and/or thickness differentials between the two glass sheets in the stacked arrangement. Increased contact pressure is believed to stem from the different shapes that different glass sheets may form during sagging. When a sheet of glass is sagged under gravity by itself, a thicker glass sheet will produce a more parabolic shape while a thinner glass sheet will produce a “bath tub”-like shape where curvature is greatest near the edges and is reduced near the center. As a result, when two sheets having different thicknesses are co-sagged, contact pressure is increased near the edges when a thin ply is sagged on top of a thick ply, and contact pressure is increased near the center when a thick ply is sagged on top of a thin ply. This increase in contact pressure is thought to contribute to the creation of bending dot defects through increasing imprintation of the separation material particles into the glass surfaces. Thus, as will be understood, the difference in sag shape generally will increase as the thickness difference and the viscosity difference between the two glass sheets increases, and thus, the sensitivity to bending dot formation also appears to increase as the thickness difference and the viscosity difference between the two glass sheets increases.

To investigate the relationship of viscosity differences of glass plies having different thicknesses, mechanical modeling studies for a co-shaped laminate including a glass ply of soda lime silicate glass (SLG) having a thickness of 2.1 mm and a glass ply of a chemically strengthened Corning® Gorilla® Glass ply (GG) having a thickness of 0.7 mm were performed and revealed that all glass surfaces, (S1, S2, S3 and S4) of the laminate exhibit different magnitudes of surface deformation as a result of bending dot defects. The two surfaces on the SLG ply (S1 and S2) have similar deformations, with a local indentation appearing on surface S2 where the surface directly contacts a particle. Similarly, the two surfaces on the GG ply (S3 and S4) have similar deformations, with a local indentation appearing on surface S3 where the surface directly contacts a particle. The main deformation (W_{g}) is scaled by the following equation (1):

$${w}_{g} ∝ \frac{P {D}_{d i s k}^{4} {t}_{d u r}}{η {h}^{3}} , \qquad ( 1 )$$

where P is the contact pressure between the two glass plies of the laminate, D_{disk} is a numerical parameter related to particle size uniformity of a separation material which quantifies the impact area of the particle, t_{dur} is the duration time of a bending process, is the viscosity of glass and h is the thickness of glass. Equation (1) can be applied in SLG ply or GG ply using the corresponding viscosity η and thickness h. From equation (1), it can be determined that larger contact pressure, larger D_{disk}, longer duration time of a bending process, lower viscosity, and/or thinner glass can result in larger surface deformations.

Exaggerated glass surface deformation profiles of co-shaped laminates as described herein were examined to determine the factors that contributed most to the formation of bending dots. The co-shaped laminates included an SLG glass ply having a thickness of 2.1 mm and a GG glass ply having a thickness of 0.7 mm and further included a PVB interlayer where the refractive index of the glass plies substantially matched the refractive index of the PVB layer. Thus, the direct surface deformation on S2 and S3 by separation powder particles does not generate optical distortion when laminated. Surface deformation only on S1 or S4 facing air (meaning not index matched) generates optical distortion as a laminate, and this optical distortion is called a bending dot because it looks like an isolated dot in shadowgraph. A visual inspection of the laminate after completion of a bending process was performed and it was observed that the deformation of surface S4 of the GG glass ply was larger than the deformation of surface S1 of the SLG glass ply.

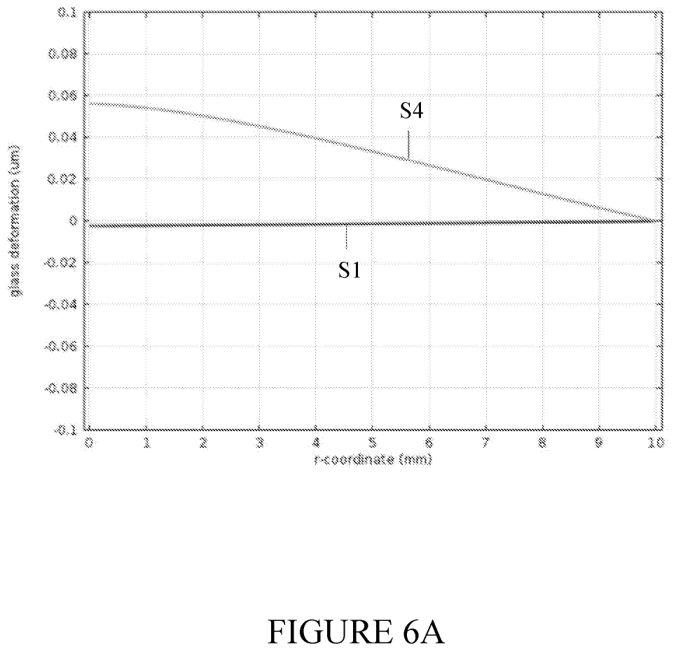

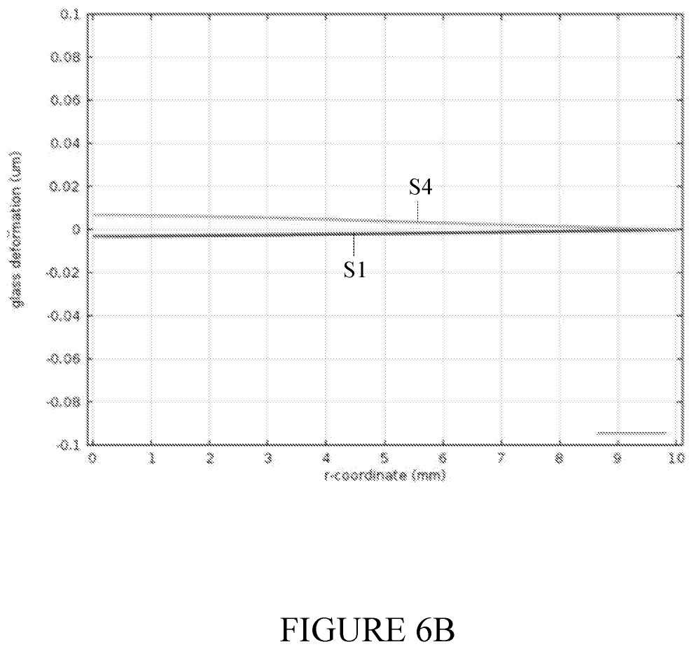

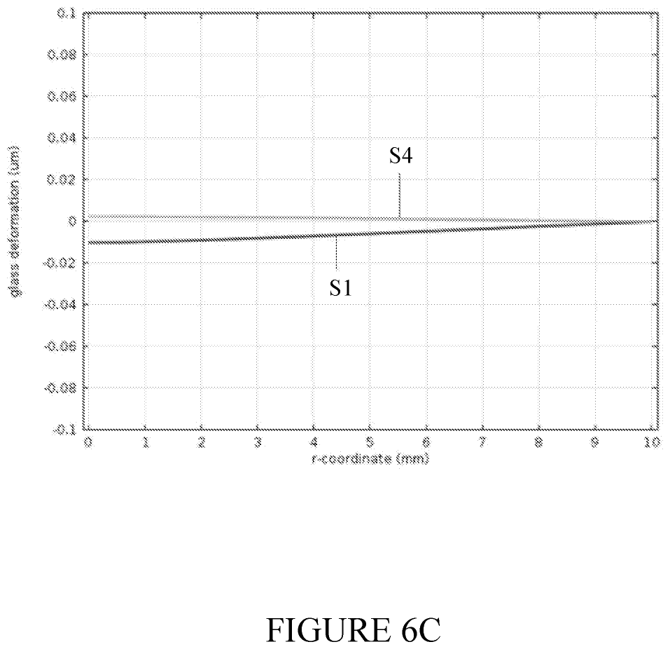

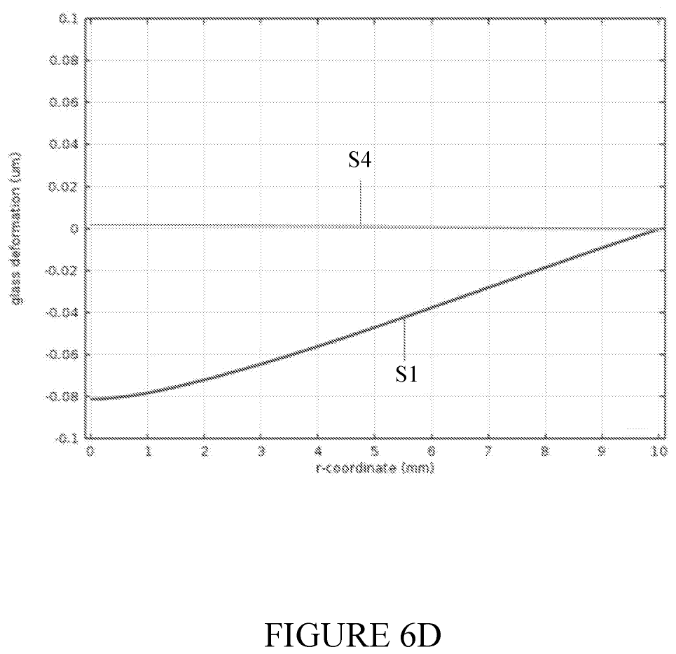

Without wishing to be bound by a particular theory, it is believed that the increased deformation observed at surface S4 of the GG ply is associated with the thickness and viscosity differences between the glass plies of the laminate. A modeling study was performed to examine the impact of the viscosity properties of the GG ply of the laminate on the formation of bending dot defects. As shown in the graphs of FIGS. 6A-6D, four hypothetical laminates were examined. Laminate 1 included an SLG glass ply having a thickness of 2.1 mm and a first virtual alkali-aluminosilicate glass (VG1) ply having a thickness of 0.7 mm where both glass plies had substantially equal viscosities. Laminate 2 included an SLG glass ply having a thickness of 2.1 mm and a second virtual alkali-aluminosilicate glass (VG2) ply having a thickness of 0.7 mm where the viscosity of the VG2 ply was about 10 times greater than the viscosity of the SLG ply. Laminate 3 included an SLG glass ply having a thickness of 2.1 mm and a third virtual alkali-aluminosilicate glass (VG3) ply having a thickness of 0.7 mm where the viscosity of the VG3 ply was about 100 times greater than the viscosity of the SLG ply. Laminate 4 included an SLG glass ply having a thickness of 2.1 mm and a fourth virtual alkali-aluminosilicate glass (VG4) ply having a thickness of 0.7 mm where the viscosity of the VG4 ply was about 1,000 times greater than the viscosity of the SLG ply.

The same duration time of the bending process was applied to each of Laminates 1-4. Bending temperature was different for each of Laminates 1-4 with: the bending temperature of Laminate 1 being the lowest; the bending temperature for Laminate 2 being greater than the bending temperature of Laminate 1 and less than the bending temperature of Laminates 3 and 4; the bending temperature of Laminate 3 being greater than the bending temperatures of Laminates 1 and 2 and less than the bending temperature of Laminate 4; and the bending temperature of Laminate 4 being the highest. The bending temperatures for each of Laminates 1-4 were established to maintain a substantially equal effective viscosity of the glass plies and thus to maintain a substantially equal final sag depth of the glass plies.

FIGS. 6A-6D show the degree of deformation across surface S1 of the SLG ply and across surface S4 of the virtual alkali-aluminosilicate glass ply. As can be seen from the data, where the viscosity of the SLG ply and the VG1 ply are substantially equal in Laminate 1, the difference in thickness between the SLG ply and the VG1 ply contributes to the formation of bending dots on surface S4. As the viscosity of the virtual alkali-aluminosilicate glass ply increases from Laminates 2-4, formation of bending dots on surface S4 decreases and formation of bending dots on surface S1 increases, with the largest deformation on surface S1 being observed in Laminate 4 where the difference in viscosities between the glass plies is greatest. In view of these observations, equation (1) can be examined with the intention of minimizing the sum of deformations at surface S1 and surface S4, which is represented by equation (2):

$$\frac{P {D}_{d i s k}^{4} {t}_{d u r}}{{η}_{S L G} {h}_{SLG}^{3}} + \frac{P {D}_{d i s k}^{4} {t}_{d u r}}{{η}_{V G} {h}_{V G}^{3}} , \qquad ( 2 )$$

where P is the contact pressure between the two glass plies of the laminate, D_{disk} is a numerical parameter related to particle size uniformity of a separation material which quantifies the impact area of the particle, t_{dur} is the duration time of a bending process, η_{SLG} is the viscosity of the SLG glass ply, η_{VG} is the viscosity of the alkali-aluminosilicate glass ply, h_{SLG} is the thickness of the SLG glass ply, and h_{VG} is the thickness of the alkali-aluminosilicate glass ply. Minimizing the sum of deformations at surface S1 and surface S4 can be achieved when η_{SLG}h³_{SLG}=η_{VG}h³_{VG}. In view of this understanding, it can be concluded that the sum of deformations at surface S1 and surface S4 are reduced as the viscosity ratio of the two glass plies of the laminate approaches the cube of the thickness ratio of the glass plies of the laminate. Table I shows viscosity ratios at which surface deformation of curved glass plies of various exemplary laminates is minimized.

TABLE I

| SLG | VG | SLG/GG | Matched GG/SLG |
|---|---|---|---|
| Thickness - | Thickness - | Thickness | Viscosity |
| h_{SLG} (mm) | h_{VG} (mm) | Ratio - (h_{SLG}/h_{VG}) | Ratio - η_{VG}/η_{SLG} |
| 2.1 | 0.7 | 3 | 27 |
| 2.1 | 0.55 | 3.818 | 55.7 |
| 2.1 | 1.0 | 2.1 | 9.3 |
| 3.2 | 0.7 | 4.571 | 95.5 |
| 3.2 | 0.55 | 5.818 | 197 |
| 3.2 | 1.0 | 3.2 | 32.8 |

According to embodiments of the present disclosure, a laminate 300 is provided comprising a first curved glass substrate 310, a second curved glass substrate 320 and an interlayer 330 disposed between the first curved glass substrate and the second curved glass substrate, as illustrated in FIG. 1. According to embodiments of the present disclosure, the first curved glass substrate 310 includes a first major surface 312, a second major surface 314 opposing the first major surface, a minor surface 313 extending between the first major surface and the second major surface, a first thickness 316 defined as the distance between the first major surface and second major surface, and a first sag depth 318. The first curved glass substrate 310 also includes a peripheral portion 315 that extends from the minor surface 313 toward the internal portion of the first glass substrate. According to embodiments of the present disclosure, the second curved glass substrate 320 includes a third major surface 322, a fourth major surface 324 opposing the third major surface, a minor surface 323 extending between the first major surface and the second major surface, a second thickness 326 defined as the distance between the third major surface and the fourth major surface, and a second sag depth 328. The first curved glass substrate 310 may also include a peripheral portion 325 that extends from the minor surface 323 toward the internal portion of the first glass substrate.

The first glass substrate 310 has a width defined as a first dimension of one of the first and second major surfaces that is orthogonal to the thickness, and a length defined as a second dimension of one of the first and second major surfaces orthogonal to both the thickness and the width. The first glass substrate 320 has a width defined as a first dimension of one of the first and second major surfaces that is orthogonal to the thickness, and a length defined as a second dimension of one of the first and second major surfaces orthogonal to both the thickness and the width. The peripheral portion 315, 325 of one of or both the first and second glass substrates may have a peripheral length extending from the minor surface 313, 323 that is less than about 20% of the respective length and width dimensions of the first and second glass substrates, or that is about 18% or less, about 16% or less, about 15% or less, about 14% or less, about 12% or less, about 10% or less, about 8% or less, or about 5% or less of the respective length and width dimensions of the first and second glass substrates.

As shown in FIG. 1, laminate 300 includes an interlayer 330 disposed between the first curved glass substrate 310 and the second curved glass substrate 320 such that it is adjacent the second major surface 314 and third major surface 322.

In the embodiment shown in FIG. 1, the first surface 312 forms a convex surface and the fourth surface 324 forms a concave surface. FIG. 1A illustrates a laminate 300A where the position of the glass substrates may be interchanged such that the interlayer 330 is disposed between the first curved glass substrate 310 and the second curved glass substrate 320 such that it is adjacent the first major surface 312 and fourth major surface 324. In such embodiments, the second surface 314 forms a convex surface and the third surface 322 forms a concave surface.

According to embodiments of the present disclosure, the first curved glass substrate (or the first glass substrate used to form the first curved glass substrate) exhibits a first viscosity (in units of poise) and the second curved glass substrate (or the second glass substrate used to form the second curved glass substrate) exhibits a second viscosity (in units of poise) that is greater than the first viscosity at a given temperature (T1). The given temperature may be any temperature, for example, but not limited to, any temperature from about 590° C. to about 650° C., such as at about 630° C. According to embodiments of the present disclosure, the ratio of the second viscosity at the given temperature (T1) to the first viscosity at the given temperature (T1) is substantially equal to the cube of the ratio of the thickness of the thicker of the first and second curved glass substrate to the thickness of the thinner of the first and second curved glass substrate.

The second viscosity may be equal to or greater than about 2 times, about 3 times, about 4 times, about 5 times, about 6 times, about 7 times, about 8 times, about 9 times, or about 10 times the first viscosity, at a temperature of 630° C. The second viscosity may be greater than or equal to 10 times the first viscosity at a given temperature, such as from about 10 times the first viscosity to about 1000 times the first viscosity (e.g., from about 25 times to about 1000 times the first viscosity, from about 50 times to about 1000 times, from about 100 times to about 1000 times, from about 150 times to about 1000 times, from about 200 times to about 1000 times, from about 250 times to about 1000 times, from about 300 times to about 1000 times, from about 350 times to about 1000 times, from about 400 times to about 1000 times, from about 450 times to about 1000 times, from about 500 times to about 1000 times, from about 10 times to about 950 times, from about 10 times to about 900 times, from about 10 times to about 850 times, from about 10 times to about 800 times, from about 10 times to about 750 times, from about 10 times to about 700 times, from about 10 times to about 650 times, from about 10 times to about 600 times, from about 10 times to about 550 times, from about 10 times to about 500 times, from about 10 times to about 450 times, from about 10 times to about 400 times, from about 10 times to about 350 times, from about 10 times to about 300 times, from about 10 times to about 250 times, from about 10 times to about 200 times, from about 10 times to about 150 times, from about 10 times to about 100 times, from about 10 times to about 50 times, or from about 10 times to about 25 times the first viscosity.

According to embodiments of the present disclosure, the first glass substrate and/or the second glass substrate (or the first glass substrate and/or second glass substrate used to form the first curved glass substrate and second curved glass substrate, respectively) may include a mechanically strengthened glass substrate (as described herein). In such laminates, the first and/or second viscosity may be a composite viscosity.

According to embodiments of the present disclosure, at 600° C., the first viscosity may be in a range from about 3×10¹⁰ poises to about 8×10¹⁰ poises, from about 4×10¹⁰ poises to about 8×10¹⁰ poises, from about 5×10¹⁰ poises to about 8×10¹⁰ poises, from about 6×10¹⁰ poises to about 8×10¹⁰ poises, from about 3×10¹⁰ poises to about 7×10¹⁰ poises, from about 3×10¹⁰ poises to about 6×10¹⁰ poises, from about 3×10¹⁰ poises to about 5×10¹⁰ poises, or from about 4×10¹⁰ poises to about 6×10¹⁰ poises.

According to embodiments of the present disclosure, at 630° C., the first viscosity may be in a range from about 1×10⁹ poises to about 1×10¹⁰ poises, from about 2×10⁹ poises to about 1×10¹⁰ poises, from about 3×10⁹ poises to about 1×10¹⁰ poises, from about 4×10⁹ poises to about 1×10¹⁰ poises, from about 5×10⁹ poises to about 1×10¹⁰ poises, from about 6×10⁹ poises to about 1×10¹⁰ poises, from about 1×10⁹ poises to about 9×10⁹ poises, from about 1×10⁹ poises to about 8×10⁹ poises, from about 1×10⁹ poises to about 7×10⁹ poises, from about 1×10⁹ poises to about 6×10⁹ poises, from about 4×10⁹ poises to about 8×10⁹ poises, or from about 5×10⁹ poises to about 7×10⁹ poises.

According to embodiments of the present disclosure, at 650° C., the first viscosity may be in a range from about 5×10⁸ poises to about 5×10⁹ poises, from about 6×10⁸ poises to about 5×10⁹ poises, from about 7×10⁸ poises to about 5×10⁹ poises, from about 8×10⁸ poises to about 5×10⁹ poises, from about 9×10⁸ poises to about 5×10⁹ poises, from about 1×10⁹ poises to about 5×10⁹ poises, from about 1×10⁹ poises to about 4×10⁹ poises, from about 1×10⁹ poises to about 3×10⁹ poises, from about 5×10⁸ poises to about 4×10⁹ poises, from about 5×10⁸ poises to about 3×10⁹ poises, from about 5×10⁸ poises to about 2×10⁹ poises, from about 5×10⁸ poises to about 1×10⁹ poises, from about 5 x 10⁸ poises to about 9×10⁸ poises, from about 5×10⁸ poises to about 8×10⁸ poises, or from about 5×10⁸ poises to about 7×10⁸ poises.

According to embodiments of the present disclosure, at 600° C., the second viscosity may be in a range from about 2×10¹¹ poises to about 1×10¹⁵ poises, from about 4×10¹¹ poises to about 1×10¹⁵ poises, from about 5×10¹¹ poises to about 1×10¹⁵ poises, from about 6×10¹¹ poises to about 1×10¹⁵ poises, from about 8×10¹¹ poises to about 1×10¹⁵ poises, from about 1×10¹² poises to about 1×10¹⁵ poises, from about 2×10¹² poises to about 1×10¹⁵ poises, from about 4×10¹² poises to about 1×10¹⁵ poises, from about 5 x 10¹² poises to about 1×10¹⁵ poises, from about 6×10¹² poises to about 1×10¹⁵ poises, from about 8×10¹² poises to about 1×10¹⁵ poises, from about 1×10¹³ poises to about 1×10¹⁵ poises, from about 2×10¹³ poises to about 1×10¹⁵ poises, from about 4×10¹³ poises to about 1×10¹⁵ poises, from about 5×10¹³ poises to about 1×10¹⁵ poises, from about 6×10¹³ poises to about 1×10¹⁵ poises, from about 8×10¹³ poises to about 1×10¹⁵ poises, from about 1×10 14 poises to about 1×10¹⁵ poises, from about 2×10¹¹ poises to about 8×10 14 poises, from about 2×10¹¹ poises to about 6×10 14 poises, from about 2×10¹¹ poises to about 5×10 14 poises, from about 2×10¹¹ poises to about 4×10 14 poises, from about 2×10¹¹ poises to about 2×10 14 poises, from about 2×10¹¹ poises to about 1×10 14 poises, from about 2×10¹¹ poises to about 8×10¹³ poises, from about 2×10¹¹ poises to about 6×10¹³ poises, from about 2×10¹¹ poises to about 5×10¹³ poises, from about 2×10¹¹ poises to about 4×10¹³ poises, from about 2×10¹¹ poises to about 2×10¹³ poises, from about 2×10¹¹ poises to about 1×10¹³ poises, from about 2×10¹¹ poises to about 8×10¹² poises, from about 2×10¹¹ poises to about 6×10¹² poises, or from about 2×10¹¹ poises to about 5×10¹² poises.

According to embodiments of the present disclosure, at 630° C., the second viscosity may be in a range from about 2×10¹⁰ poises to about 1×10¹³ poises, from about 4×10¹⁰ poises to about 1×10¹³ poises, from about 5×10¹⁰ poises to about 1×10¹³ poises, from about 6×10¹⁰ poises to about 1×10¹³ poises, from about 8×10¹⁰ poises to about 1×10¹³ poises, from about 1×10¹¹ poises to about 1×10¹³ poises, from about 2×10¹¹ poises to about 1×10¹³ poises, from about 4×10¹¹ poises to about 1×10¹³ poises, from about 5×10¹¹ poises to about 1×10¹³ poises, from about 6×10¹¹ poises to about 1×10¹³ poises, from about 8×10¹¹ poises to about 1×10¹³ poises, from about 1×10¹² poises to about 1×10¹³ poises, from about 2×10¹⁰ poises to about 8×10¹² poises, from about 2×10¹⁰ poises to about 6×10¹² poises, from about 2×10¹⁰ poises to about 5×10¹² poises, from about 2×10¹⁰ poises to about 4×10¹² poises, from about 2×10¹⁰ poises to about 2×10¹² poises, from about 2×10¹⁰ poises to about 1×10¹² poises, from about 2×10¹⁰ poises to about 8×10¹¹ poises, from about 2×10¹⁰ poises to about 6×10¹¹ poises, from about 2×10¹⁰ poises to about 5×10¹¹ poises, from about 2×10¹⁰ poises to about 4×10¹¹ poises, or from about 2 x 10¹⁰ poises to about 2×10¹¹ poises.

According to embodiments of the present disclosure, at 650° C., the second viscosity is in a range from about 1×10¹⁰ poises to about 1×10¹³ poises, from about 2×10¹⁰ poises to about 1×10¹³ poises, from about 4×10¹⁰ poises to about 1×10¹³ poises, from about 5×10¹⁰ poises to about 1×10¹³ poises, from about 6×10¹⁰ poises to about 1×10¹³ poises, from about 8×10¹⁰ poises to about 1×10¹³ poises, from about 1×10¹¹ poises to about 1×10¹³ poises, from about 2×10¹¹ poises to about 1×10¹³ poises, from about 4×10¹¹ poises to about 1×10¹³ poises, from about 4×10¹¹ poises to about 1×10¹³ poises, from about 5×10¹¹ poises to about 1×10¹³ poises, from about 6×10¹¹ poises to about 1×10¹³ poises, from about 8×10¹¹ poises to about 1×10¹³ poises, from about 1×10¹² poises to about 1×10¹³ poises, from about 1×10¹⁰ poises to about 8×10¹² poises, from about 1×10¹⁰ poises to about 6×10¹² poises, from about 1×10¹⁰ poises to about 5×10¹² poises, from about 1×10¹⁰ poises to about 4×10¹² poises, from about 1×10¹⁰ poises to about 2×10¹² poises, from about 1×10¹⁰ poises to about 1×10¹² poises, from about 1×10¹⁰ poises to about 8×10¹¹ poises, from about 1×10¹⁰ poises to about 6×10¹¹ poises, from about 1×10¹⁰ poises to about 5×10¹¹ poises, from about 1×10¹⁰ poises to about 4×10¹¹ poises, from about 1×10¹⁰ poises to about 2×10¹¹ poises, or from about 1×10¹⁰ poises to about 1×10¹¹ poises.

According to embodiments of the present disclosure, the first curved glass substrate (or the first glass substrate used to form the first curved glass substrate) exhibits a first viscosity η₁ of 1×10¹¹ poises at a given temperature (T1) and the second curved glass substrate (or the second glass substrate used to form the second curved glass substrate) exhibits a second viscosity η₂ (in units of poise) that is greater than the first viscosity η₁ at the given temperature (T1). The given temperature (T1) may be any temperature, for example, but not limited to, any temperature from about 590° C. to about 650° C., such as at about 630° C. According to embodiments of the present disclosure, the ratio of the second viscosity η₂ at the given temperature (T1) to the first viscosity η₂ at the given temperature (T1), or η₂/η₁, may be approximately equal to the cube of the ratio of the thickness of the thicker of the first and second curved glass substrate to the thickness of the thinner of the first and second curved glass substrate, or (h₁/h₂)³. For example, the value of the ratio η₂/η₁ may be between about (h₁/h₂)^{2.55} and about (h₁/h₂)^{3 45 ,} or between about (h₁/h₂)^{2.62} and about (h₁/h₂)^{3 38 ,} or even between about (h₁/h₂)^{2.73} and about (h₁/h₂)^{3.27}.

The first curved substrate and the second curved substrate (or the first glass substrate and the second glass substrate used to form the first curved glass substrate and the second curved glass substrate, respectively) may have a sag temperature that differs from one another. As used herein, “sag temperature” means the temperature at which the viscosity of the glass substrate is about 10^{9.9} poises. The sag temperature is determined by fitting the Vogel-Fulcher-Tamman (VFT) equation: Log h=A+B/(T−C), where T is the temperature, A, B and C are fitting constants and h is the dynamic viscosity, to annealing point data measured using the bending beam viscosity (BBV) measurement, to softening point data measured by fiber elongation. The first curved glass substrate (or the first glass substrate used to form the first curved glass substrate) may have a first sag temperature and the second curved glass substrate (or the second glass substrate used to form the second curved glass substrate) may have a second sag temperature that is greater than the first sag temperature. For example, the first sag temperature may be in a range from about 600° C. to about 650° C., from about 600° C. to about 640° C., from about 600° C. to about 630° C., from about 600° C. to about 625° C., from about 600° C. to about 620° C., from about 610° C. to about 650° C., from about 620° C. to about 650° C., from about 625° C. to about 650° C., from about 630° C. to about 650° C., from about 620° C. to about 640° C., or from about 625° C. to about 635° C. Additionally, the second sag temperature may be greater than about 650° C. (e.g., from greater than about 650° C. to about 800° C., from greater than about 650° C. to about 790° C., from greater than about 650° C. to about 780° C., from greater than about 650° C. to about 770° C., from greater than about 650° C. to about 760° C., from greater than about 650° C. to about 750° C., from greater than about 650° C. to about 740° C., from greater than about 650° C. to about 740° C., from greater than about 650° C. to about 730° C., from greater than about 650° C. to about 725° C., from greater than about 650° C. to about 720° C., from greater than about 650° C. to about 710° C., from greater than about 650° C. to about 700° C., from greater than about 650° C. to about 690° C., from greater than about 650° C. to about 680° C., from about 660° C. to about 750° C., from about 670° C. to about 750° C., from about 680° C. to about 750° C., from about 690° C. to about 750° C., from about 700° C. to about 750° C., from about 710° C. to about 750° C., or from about 720° C. to about 750° C.

According to embodiments of the present disclosure, the difference between the first sag temperature and the second sag temperature may be about 5° C. or greater, about 10° C. or greater, about 15° C. or greater, about 20° C. or greater, about 25° C. or greater, about 30° C. or greater, or about 35° C. or greater. For example, the difference between the first sag temperature and the second sag temperature may be in a range from about 5° C. to about 150° C., from about 10° C. to about 150° C., from about 15° C. to about 150° C., from about 20° C. to about 150° C., from about 25° C. to about 150° C., from about 30° C. to about 150° C., from about 40° C. to about 150° C., from about 50° C. to about 150° C., from about 60° C. to about 150° C., from about 80° C. to about 150° C., from about 100° C. to about 150° C., from about 5° C. to about 140° C., from about 5° C. to about 120° C., from about 5° C. to about 100° C., from about 5° C. to about 80° C., from about 5° C. to about 60° C., or from about 5° C. to about 50° C.

According to embodiments of the present disclosure, one or both of the first sag depth 318 and the second sag depth 328 may be about 2 mm or greater. For example, one or both of the first sag depth 318 and the second sag depth 328 may be in a range from about 2 mm to about 30 mm, from about 4 mm to about 30 mm, from about 5 mm to about 30 mm, from about 6 mm to about 30 mm, from about 8 mm to about 30 mm, from about 10 mm to about 30 mm, from about 12 mm to about 30 mm, from about 14 mm to about 30 mm, from about 15 mm to about 30 mm, from about 2 mm to about 28 mm, from about 2 mm to about 26 mm, from about 2 mm to about 25 mm, from about 2 mm to about 24 mm, from about 2 mm to about 22 mm, from about 2 mm to about 20 mm, from about 2 mm to about 18 mm, from about 2 mm to about 16 mm, from about 2 mm to about 15 mm, from about 2 mm to about 14 mm, from about 2 mm to about 12 mm, from about 2 mm to about 10 mm, from about 2 mm to about 8 mm, from about 6 mm to about 20 mm, from about 8 mm to about 18 mm, from about 10 mm to about 15 mm, from about 12 mm to about 22 mm, from about 15 mm to about 25 mm, or from about 18 mm to about 22 mm.

Optionally, the first sag depth 318 and the second sag depth 328 may be substantially equal to one another. Alternatively, the first sag depth is within 10% of the second sag depth. For example, the first sag depth is within 9%, within 8%, within 7%, within 6% or within 5% of the second sag depth. For illustration, the second sag depth is about 15 mm, and the first sag depth is in a range from about 14.5 mm to about 16.5 mm (or within 10% of the second sag depth).

Laminates as described herein may include a first curved glass substrate and a second curved glass substrate comprising a shape deviation therebetween of ±5 mm or less as measured by an optical three-dimensional scanner such as the ATOS Triple Scan commercially available from GOM GmbH, located in Braunschweig, Germany. The shape deviation may be measured between the second surface 314 and the third surface 322, or between the first surface 312 and the fourth surface 324. The shape deviation between the first glass substrate and the second glass substrate may be about ±4 mm or less, about ±3 mm or less, about ±2 mm or less, about ±1 mm or less, about ±0.8 mm or less, about ±0.6 mm or less, about ±0.5 mm or less, about ±0.4 mm or less, about ±0.3 mm or less, about ±0.2 mm or less, or about ±0.1 mm or less. As used herein, the shape deviation refers to the maximum shape deviation measured on the respective surfaces.

According to embodiments of the present disclosure, one or both of the first major surface 312 and the fourth major surface 324 may exhibit minimal optical distortion. For example, one or both of the first major surface 312 and the fourth major surface 324 exhibit less than about 400 millidiopters, less than about 300 millidiopters, or less than about 250 millidiopters, as measured by an optical distortion detector using transmission optics according to ASTM 1561. A suitable optical distortion detector is commercially available from ISRA VISIION AG, located in Darmstadt, Germany, under the tradename SCREENSCAN-Faultfinder. One of or both the first major surface 312 and the fourth major surface 324 may exhibit about 190 millidiopters or less, about 180 millidiopters or less, about 170 millidiopters or less, about 160 millidiopters or less, about 150 millidiopters or less, about 140 millidiopters or less, about 130 millidiopters or less, about 120 millidiopters or less, about 110 millidiopters or less, about 100 millidiopters or less, about 90 millidiopters or less, about 80 millidiopters or less, about 70 millidiopters or less, about 60 millidiopters or less, or about 50 millidiopters or less. As used herein, the optical distortion refers to the maximum optical distortion measured on the respective surfaces.

According to embodiments of the present disclosure, the first major surface or the second major surface of the first curved glass substrate may exhibit low membrane tensile stress. Membrane tensile stress can occur during cooling of curved substrates and laminates. As the glass cools, the major surfaces and edge surfaces (orthogonal to the major surfaces) can develop surface compression, which is counterbalanced by a central region exhibiting a tensile stress. Bending or shaping can introduce additional surface tension near the edge and causes the central tensile region to approach the glass surface. Accordingly, membrane tensile stress is the tensile stress measured near the edge (e.g., about 10-25 mm from the edge surface). Laminates as described herein may include a membrane tensile stress at the first major surface or the second major surface of the first curved glass substrate that is less than about 7 megaPascals (MPa) as measured by a surface stress meter according to ASTM C1279. An example of such a surface stress meter is commercially available from Strainoptic Technologies under the trademark GASP® (Grazing Angle Surface Polarimeter). The membrane tensile stress at the first major surface or the second major surface of the first curved glass substrate may be about 6 MPa or less, about 5 MPa or less, about 4 MPa or less, or about 3 MPa or less. The lower limit of membrane tensile stress may be about 0.01 MPa or about 0.1 MPa. As recited herein, stress is designated as either compressive or tensile, with the magnitude of such stress provided as an absolute value.

According to embodiments of the present disclosure, the membrane compressive stress at the first major surface or the second major surface of the first curved glass substrate may be less than about 7 megaPascals (MPa) as measured by a surface stress meter according to ASTM C1279. A surface stress meter such as the surface stress meter commercially available from Strainoptic Technologies under the trademark GASP® (Grazing Angle Surface Polarimeter) may be used. The membrane compressive stress at the first major surface or the second major surface of the first curved glass substrate may be about 6 MPa or less, about 5 MPa or less, about 4 MPa or less, or about 3 MPa or less. The lower limit of membrane compressive stress may be about 0.01 MPa or about 0.1 MPa.

Laminates as described herein may have a thickness of about 6.85 mm or less, or about 5.85 mm or less, where the thickness comprises the sum of thicknesses of the first curved glass substrate, the second curved glass substrate, and the interlayer. In various embodiments, the laminate may have a thickness in the range of about 1.8 mm to about 6.85 mm, or in the range of about 1.8 mm to about 5.85 mm, or in the range of about 1.8 mm to about 5.0 mm, or 2.1 mm to about 6.85 mm, or in the range of about 2.1 mm to about 5.85 mm, or in the range of about 2.1 mm to about 5.0 mm, or in the range of about 2.4 mm to about 6.85 mm, or in the range of about 2.4 mm to about 5.85 mm, or in the range of about 2.4 mm to about 5.0 mm, or in the range of about 3.4 mm to about 6.85 mm, or in the range of about 3.4 mm to about 5.85 mm, or in the range of about 3.4 mm to about 5.0 mm.

Laminates as described herein may exhibit radii of curvature that is less than about 1000 mm, or less than about 750 mm, or less than about 500 mm, or less than about 300 mm. Laminates as described herein may exhibit at least one radius of curvature of about 10 m or less, or about 5 m or less along at least one axis. Laminates as described herein may have a radius of curvature of 5 m or less along at least a first axis and along the second axis that is perpendicular to the first axis. According to embodiment of the present disclosure, laminates as described herein may have a radius of curvature of 5 m or less along at least a first axis and along the second axis that is not perpendicular to the first axis.

According to embodiments of the present disclosure, the second curved glass substrate (or the second glass substrate used to form the second curved glass substrate) may be relatively thin in comparison to the first curved glass substrate (or the first glass substrate used to form the first curved glass substrate). In other words, the first curved glass substrate (or the first glass substrate used to form the first curved glass substrate) may have a thickness greater than the second curved glass substrate (or the second glass substrate used to form the second curved glass substrate). The first thickness (or the thickness of the first glass substrate used to form the first curved glass substrate) may be more than two times the second thickness, or in the range from about 1.5 times to about 10 times the second thickness (e.g., from about 1.75 times to about 10 times, from about 2 times to about 10 times, from about 2.1 times to about 10 times, from about 2.25 times to about 10 times, from about 2.5 times to about 10 times, from about 2.75 times to about 10 times, from about 3 times to about 10 times, from about 3.25 times to about 10 times, from about 3.5 times to about 10 times, from about 3.75 times to about 10 times, from about 4 times to about 10 times, from about 1.5 times to about 9 times, from about 1.5 times to about 8 times, from about 1.5 times to about 7.5 times, from about 1.5 times to about 7 times, from about 1.5 times to about 6.5 times, from about 1.5 times to about 6 times, from about 1.5 times to about 5.5 times, from about 1.5 times to about 5 times, from about 1.5 times to about 4.5 times, from about 1.5 times to about 4 times, from about 1.5 times to about 3.5 times, from about 2 times to about 7 times, from about 2.5 times to about 6 times, from about 3 times to about 6 times).

According to embodiments of the present disclosure, the first curved glass substrate (or the first glass substrate used to form the first curved glass substrate) and the second curved glass substrate (or the second glass substrate used to form the second curved glass substrate) may have the same thickness. In one or more specific embodiments, the first curved glass substrate (or the first glass substrate used to form the first curved glass substrate) is more rigid or has a greater stiffness than the second curved glass substrate (or the second glass substrate used to form the second curved glass substrate), and in very specific embodiments, both the first curved glass substrate (or the first glass substrate used to form the first curved glass substrate) and the second curved glass substrate (or the second glass substrate used to form the second curved glass substrate) have a thickness in the range of about 0.2 mm and about 1.6 mm.

According to embodiments of the present disclosure, either one or both of the first thickness (or the thickness of the first glass substrate used to form the first curved glass substrate) and the second thickness (or the thickness of the second glass substrate used to form the second curved glass substrate) may be less than about 1.6 mm (e.g., about 1.55 mm or less, about 1.5 mm or less, about 1.45 mm or less, about 1.4 mm or less, about 1.35 mm or less, about 1.3 mm or less, about 1.25 mm or less, about 1.2 mm or less, about 1.15 mm or less, about 1.1 mm or less, about 1.05 mm or less, about 1 mm or less, about 0.95 mm or less, about 0.9 mm or less, about 0.85 mm or less, about 0.8 mm or less, about 0.75 mm or less, about 0.7 mm or less, about 0.65 mm or less, about 0.6 mm or less, about 0.55 mm or less, about 0. 5mm or less, about 0.45 mm or less, about 0.4 mm or less, about 0.35 mm or less, about 0.3 mm or less, about 0.25 mm or less, about 0.2 mm or less, about 0.15 mm or less, or about 0.1 mm or less). The lower limit of thickness may be about 0.1 mm, about 0.2mm or about 0.3 mm. According to embodiments of the present disclosure, either one or both of the first thickness (or the thickness of the first glass substrate used to form the first curved glass substrate) and the second thickness (or the thickness of the second glass substrate used to form the second curved glass substrate) may be in the range from about 0.1 mm to less than about 1.6 mm, from about 0.1 mm to about 1.5 mm, from about 0.1 mm to about 1.4 mm, from about 0.1 mm to about 1.3 mm, from about 0.1 mm to about 1.2 mm, from about 0.1 mm to about 1.1 mm, from about 0.1 mm to about 1 mm, from about 0.1 mm to about 0.9 mm, from about 0.1 mm to about 0.8 mm, from about 0.1 mm to about 0.7 mm, from about 0.1 mm, from about 0.2 mm to less than about 1.6 mm, from about 0.3 mm to less than about 1.6 mm, from about 0.4 mm to less than about 1.6 mm, from about 0.5 mm to less than about 1.6 mm, from about 0.6 mm to less than about 1.6 mm, from about 0.7 mm to less than about 1.6 mm, from about 0.8 mm to less than about 1.6 mm, from about 0.9 mm to less than about 1.6 mm, or from about 1 mm to about 1.6 mm.

When one of the first thickness (or the thickness of the first glass substrate used to form the first curved glass substrate) and the second thickness (or the thickness of the second glass substrate used to form the second curved glass substrate) is less than about 1.6 mm, the other of the first thickness (or the thickness of the first glass substrate used to form the first curved glass substrate) and the second thickness (or the thickness of the second glass substrate used to form the second curved glass substrate) may be about 1.6 mm or greater. In such embodiments, the first thickness (or the thickness of the first glass substrate used to form the first curved glass substrate) and the second thickness (or the thickness of the second glass substrate used to form the second curved glass substrate) differ from one another. For example, where one of the first thickness (or the thickness of the first glass substrate used to form the first curved glass substrate) and the second thickness (or the thickness of the second glass substrate used to form the second curved glass substrate) is less than about 1.6 mm, the other of the first thickness (or the thickness of the first glass substrate used to form the first curved glass substrate) and the second thickness (or the thickness of the second glass substrate used to form the second curved glass substrate) may be about 1.7 mm or greater, about 1.75 mm or greater, about 1.8 mm or greater, about 1.7 mm or greater, about 1.7 mm or greater, about 1.7 mm or greater, about 1.85 mm or greater, about 1.9 mm or greater, about 1.95 mm or greater, about 2 mm or greater, about 2.1 mm or greater, about 2.2 mm or greater, about 2.3 mm or greater, about 2.4 mm or greater, 2.5 mm or greater, 2.6 mm or greater, 2.7 mm or greater, 2.8 mm or greater, 2.9 mm or greater, 3 mm or greater, 3.2 mm or greater, 3.4 mm or greater, 3.5 mm or greater, 3.6 mm or greater, 3.8 mm or greater, 4 mm or greater, 4.2 mm or greater, 4.4 mm or greater, 4.6 mm or greater, 4.8 mm or greater, 5 mm or greater, 5.2 mm or greater, 5.4 mm or greater, 5.6 mm or greater, 5.8 mm or greater, or 6 mm or greater. The first thickness (or the thickness of the first glass substrate used to form the first curved glass substrate) or the second thickness (or the thickness of the second glass substrate used to form the second curved glass substrate) may be in a range from about 1.6 mm to about 6 mm, from about 1.7 mm to about 6 mm, from about 1.8 mm to about 6 mm, from about 1.9 mm to about 6 mm, from about 2 mm to about 6 mm, from about 2.1 mm to about 6 mm, from about 2.2 mm to about 6 mm, from about 2.3 mm to about 6 mm, from about 2.4 mm to about 6 mm, from about 2.5 mm to about 6 mm, from about 2.6 mm to about 6 mm, from about 2.8 mm to about 6 mm, from about 3 mm to about 6 mm, from about 3.2 mm to about 6 mm, from about 3.4 mm to about 6 mm, from about 3.6 mm to about 6 mm, from about 3.8 mm to about 6 mm, from about 4 mm to about 6 mm, from about 1.6 mm to about 5.8 mm, from about 1.6 mm to about 5.6 mm, from about 1.6 mm to about 5.5 mm, from about 1.6 mm to about 5.4 mm, from about 1.6 mm to about 5.2 mm, from about 1.6 mm to about 5 mm, from about 1.6 mm to about 4.8 mm, from about 1.6 mm to about 4.6 mm, from about 1.6 mm to about 4.4 mm, from about 1.6 mm to about 4.2 mm, from about 1.6 mm to about 4 mm, from about 3.8 mm to about 5.8 mm, from about 1.6 mm to about 3.6 mm, from about 1.6 mm to about 3.4 mm, from about 1.6 mm to about 3.2 mm, or from about 1.6 mm to about 3 mm.

In one or more specific examples, the first thickness (or the thickness of the first glass substrate used to form the first curved glass substrate) is from about 1.6 mm to about 3.5 mm, and the second thickness (or the thickness of the second glass substrate used to form the second curved glass substrate) is in a range from about 0.1 mm to less than about 1.6 mm.

According to embodiments of the present disclosure, laminates as described herein may be substantially free of visual distortion as measured by ASTM C1652/C1652M. In specific embodiments, the first curved glass substrate and/or the second curved glass substrate are substantially free of wrinkles or distortions that can be visually detected by the naked eye, according to ASTM C1652/C1652M.

According to embodiments of the present disclosure, the first major surface 312 or the second major surface 314 may comprise a surface compressive stress of less than 3 MPa as measured by a surface stress meter, such as the surface stress meter commercially available under the tradename FSM-6000, from Orihara Industrial Co., Ltd. (Japan) (“FSM”). The first curved glass substrate may be unstrengthened as will be described herein (but may optionally be annealed), and may exhibit a surface compressive stress of less than about 3 MPa, or about 2.5 MPa or less, 2 MPa or less, 1.5 MPa or less, 1 MPa or less, or about 0.5 MPa or less. Such surface compressive stress ranges may be present on both the first major surface and the second major surface.

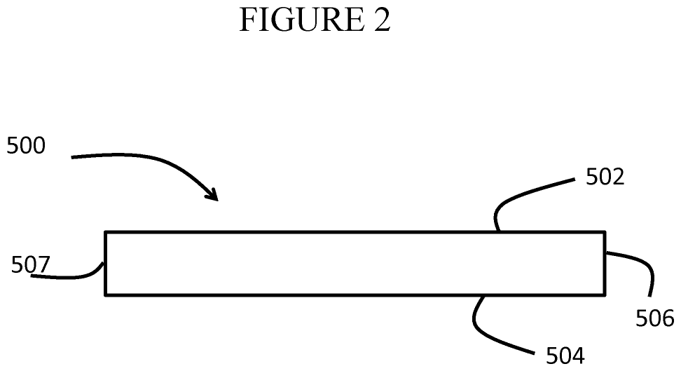

According to embodiments of the present disclosure, the first and second glass substrates used to form the first curved glass substrate and second curved substrate may be provided as a substantially planar sheet 500 prior to being co-shaped to form a first curved glass substrate and second curved glass substrate, as shown in FIG. 2. The substantially planar sheets may include first and second major opposing surfaces 502, 504 and minor opposing surfaces 506, 507. In some instances, one or both of the first glass substrate and the second glass substrate used to form the first curved glass substrate and second curved substrate may have a 3D or 2.5D shape that does not exhibit the sag depth desired and will eventually be formed during the co-shaping process and present in the resulting laminate. Additionally or alternatively, the thickness of the one or both of the first curved glass substrate (or the first glass substrate used to form the first curved glass substrate) and the second curved glass substrate (or the second glass substrate used to form the second curved glass substrate) may be constant along one or more dimension or may vary along one or more of its dimensions for aesthetic and/or functional reasons. For example, the edges of one or both of the first curved glass substrate (or the first glass substrate used to form the first curved glass substrate) and the second curved glass substrate (or the second glass substrate used to form the second curved glass substrate) may be thicker as compared to more central regions of the glass substrate.

The length, width and thickness dimensions of the first curved glass substrate (or the first glass substrate used to form the first curved glass substrate) and the second curved glass substrate (or the second glass substrate used to form the second curved glass substrate) may also vary according to the article application or use. The first curved glass substrate 310 (or the first glass substrate used to form the first curved glass substrate) may include a first length and a first width (the first thickness is orthogonal both the first length and the first width), and the second curved glass substrate 320 (or the second glass substrate used to form the second curved glass substrate) may a second length and a second width orthogonal the second length (the second thickness is orthogonal both the second length and the second width). Either one of or both of the first length and the first width may be about 0.25 meters (m) or greater. For example, the first length and/or the second length may be in a range from about 1 m to about 3 m, from about 1.2 m to about 3 m, from about 1.4 m to about 3 m, from about 1.5 m to about 3 m, from about 1.6 m to about 3 m, from about 1.8 m to about 3 m, from about 2 m to about 3 m, from about 1 m to about 2.8 m, from about 1 m to about 2.8 m, from about 1 m to about 2.8 m, from about 1 m to about 2.8 m, from about 1 m to about 2.6 m, from about 1 m to about 2.5 m, from about 1 m to about 2.4 m, from about 1 m to about 2.2 m, from about 1 m to about 2 m, from about 1 m to about 1.8 m, from about 1 m to about 1.6 m, from about 1 m to about 1.5 m, from about 1.2 m to about 1.8 m or from about 1.4 m to about 1.6 m.

Also as an example, the first width and/or the second width may be in a range from about 0.5 m to about 2 m, from about 0.6 m to about 2 m, from about 0.8 m to about 2 m, from about 1 m to about 2 m, from about 1.2 m to about 2 m, from about 1.4 m to about 2 m, from about 1.5 m to about 2 m, from about 0.5 m to about 1.8 m, from about 0.5 m to about 1.6 m, from about 0.5 m to about 1.5 m, from about 0.5 m to about 1.4 m, from about 0.5 m to about 1.2 m, from about 0.5 m to about 1 m, from about 0.5 m to about 0.8 m, from about 0.75 m to about 1.5 m, from about 0.75 m to about 1.25 m, or from about 0.8 m to about 1.2 m.

According to embodiments of the present disclosure, the second length may be within 5% of the first length (e.g., about 5% or less, about 4% or less, about 3% or less, or about 2% or less). For example, if the first length is 1.5 m, the second length may be in a range from about 1.425 m to about 1.575 m and still be within 5% of the first length. The second width may be within 5% of the first width (e.g., about 5% or less, about 4% or less, about 3% or less, or about 2% or less). For example, if the first width is 1 m, the second width may be in a range from about 1.05 m to about 0.95 m and still be within 5% of the first width.

According to embodiments of the present disclosure, the first curved glass substrate (or the first glass substrate used to form the first curved glass substrate) and the second curved glass substrate (or the second glass substrate used to form the second curved glass substrate) may have a refractive index in the range from about 1.2 to about 1.8, from about 1.2 to about 1.75, from about 1.2 to about 1.7, from about 1.2 to about 1.65, from about 1.2 to about 1.6, from about 1.2 to about 1.55, from about 1.25 to about 1.8, from about 1.3 to about 1.8, from about 1.35 to about 1.8, from about 1.4 to about 1.8, from about 1.45 to about 1.8, from about 1.5 to about 1.8, from about 1.55 to about 1.8, of from about 1.45 to about 1.55. As used herein, the refractive index values are with respect to a wavelength of 550 nm.

According to embodiments of the present disclosure, the first curved glass substrate (or the first glass substrate used to form the first curved glass substrate) and the second curved glass substrate (or the second glass substrate used to form the second curved glass substrate) may be characterized by the manner in which it is formed. For instance, one of or both of the first curved glass substrate (or the first glass substrate used to form the first curved glass substrate) and the second curved glass substrate (or the second glass substrate used to form the second curved glass substrate) may be characterized as float-formable (i.e., formed by a float process), down-drawable and, in particular, fusion-formable or slot-drawable (i.e., formed by a down draw process such as a fusion draw process or a slot draw process).

One of or both of the first curved glass substrate (or the first glass substrate used to form the first curved glass substrate) and the second curved glass substrate (or the second glass substrate used to form the second curved glass substrate) described herein may be formed by a float process. A float-formable glass substrate may be characterized by smooth surfaces and uniform thickness is made by floating molten glass on a bed of molten metal, typically tin. In an example process, molten glass that is fed onto the surface of the molten tin bed forms a floating glass ribbon. As the glass ribbon flows along the tin bath, the temperature is gradually decreased until the glass ribbon solidifies into a solid glass substrate that can be lifted from the tin onto rollers. Once off the bath, the glass substrate can be cooled further and annealed to reduce internal stress.

One of or both of the first curved glass substrate (or the first glass substrate used to form the first curved glass substrate) and the second curved glass substrate (or the second glass substrate used to form the second curved glass substrate) may be formed by a down- draw process. Down-draw processes produce glass substrates having a substantially uniform thickness that possess relatively pristine surfaces. Because the average flexural strength of the glass substrates is generally controlled by the amount and size of surface flaws, a pristine surface that has had minimal contact has a higher initial strength. In addition, down drawn glass substrates have a very flat, smooth surface that can be used in its final application without costly grinding and polishing.

One of or both of the first curved glass substrate (or the first glass substrate used to form the first curved glass substrate) and the second curved glass substrate (or the second glass substrate used to form the second curved glass substrate) may be described as fusion-formable (i.e., formable using a fusion draw process). The fusion process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass substrate. The fusion draw method offers the advantage that, because the two glass films flowing over the channel fuse together, neither of the outside surfaces of the resulting glass substrate comes in contact with any part of the apparatus. Thus, the surface properties of the fusion drawn glass substrate are not affected by such contact.

One of or both of the first curved glass substrate (or the first glass substrate used to form the first curved glass substrate) and the second curved glass substrate (or the second glass substrate used to form the second curved glass substrate) described herein may be formed by a slot draw process. The slot draw process is distinct from the fusion draw method. In slow draw processes, the molten raw material glass is provided to a drawing tank. The bottom of the drawing tank has an open slot with a nozzle that extends the length of the slot. The molten glass flows through the slot/nozzle and is drawn downward as a continuous glass substrate and into an annealing region.

According to embodiments of the present disclosure, one of or both of the first curved glass substrate (or the first glass substrate used to form the first curved glass substrate) and the second curved glass substrate (or the second glass substrate used to form the second curved glass substrate) may be glass (e.g., soda lime glass, alkali aluminosilicate glass, alkali containing borosilicate glass and/or alkali aluminoborosilicate glass) or glass-ceramic. One of or both of the first curved glass substrate (or the first glass substrate used to form the first curved glass substrate) and the second curved glass substrate (or the second glass substrate used to form the second curved glass substrate) described herein may exhibit an amorphous microstructure and may be substantially free of crystals or crystallites. In other words, the glass substrates of certain embodiments exclude glass-ceramic materials. In some embodiments, one of or both the first curved glass substrate (or the first glass substrate used to form the first curved glass substrate) and the second curved glass substrate (or the second glass substrate used to form the second curved glass substrate) is a glass-ceramic. Examples of suitable glass-ceramics include Li₂O—Al₂O₃—SiO₂ system (i.e. LAS-System) glass-ceramics, MgO—Al₂O₃—SiO₂ system (i.e. MAS-System) glass-ceramics, and glass-ceramics including crystalline phases of any one or more of mullite, spinel, α-quartz, β-quartz solid solution, petalite, lithium dissilicate, β-spodumene, nepheline, and alumina. Such substrates including glass-ceramic materials may be strengthened as described herein.

According to embodiments of the present disclosure, one of or both the first curved glass substrate (or the first glass substrate used to form the first curved glass substrate) and the second curved glass substrate (or the second glass substrate used to form the second curved glass substrate) may exhibit a total solar transmittance of about 92% or less, over a wavelength range from about 300 nm to about 2500 nm, when the glass substrate has a thickness of 0.7 mm. For example, the one of or both the first and second glass substrates exhibits a total solar transmittance in a range from about 60% to about 92%, from about 62% to about 92%, from about 64% to about 92%, from about 65% to about 92%, from about 66% to about 92%, from about 68% to about 92%, from about 70% to about 92%, from about 72% to about 92%, from about 60% to about 90%, from about 60% to about 88%, from about 60% to about 86%, from about 60% to about 85%, from about 60% to about 84%, from about 60% to about 82%, from about 60% to about 80%, from about 60% to about 78%, from about 60% to about 76%, from about 60% to about 75%, from about 60% to about 74%, or from about 60% to about 72%.

According to embodiments of the present disclosure, one or both of the first curved glass substrate (or the first glass substrate used to form the first curved glass substrate) and the second curved glass substrate (or the second glass substrate used to form the second curved glass substrate) may be tinted. In such embodiments, the first curved glass substrate (or the first glass substrate used to form the first curved glass substrate) may comprise a first tint and the second curved glass substrate (or the second glass substrate used to form the second curved glass substrate) may comprise a second tint that differs from the first tint, in the CIE L*a*b* (CIELAB) color space. Optionally, the first tint and the second tint may be the same. Alternatively, the first curved glass substrate may comprise a first tint, and the second curved glass substrate may not be tinted, or the second curved glass substrate may comprise a second tint, and the first curved glass substrate may not be tinted.

According to embodiments of the present disclosure, one of or both of the first curved glass substrate (or the first glass substrate used to form the first curved glass substrate) and the second curved glass substrate (or the second glass substrate used to form the second curved glass substrate) may exhibit an average transmittance in the range from about 75% to about 85%, at a thickness of 0.7 mm or 1 mm, over a wavelength range from about 380 nm to about 780 nm. For example, the average transmittance at this thickness and over this wavelength range may be in a range from about 75% to about 84%, from about 75% to about 83%, from about 75% to about 82%, from about 75% to about 81%, from about 75% to about 80%, from about 76% to about 85%, from about 77% to about 85%, from about 78% to about 85%, from about 79% to about 85%, or from about 80% to about 85%. According to embodiments of the present disclosure, one of or both of the first curved glass substrate (or the first glass substrate used to form the first curved glass substrate) and the second curved glass substrate (or the second glass substrate used to form the second curved glass substrate) may exhibit Tᵤᵥ₋₃₈₀ or Tᵤᵥ₋₄₀₀ of 50% or less (e.g., 49% or less, 48% or less, 45% or less, 40% or less, 30% or less, 25% or less, 23% or less, 20% or less, or 15% or less), at a thickness of 0.7 mm or 1 mm, over a wavelength range from about 300 nm to about 400 nm.

According to embodiments of the present disclosure, one of or both of the first curved glass substrate (or the first glass substrate used to form the first curved glass substrate) and the second curved glass substrate (or the second glass substrate used to form the second curved glass substrate) may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

Such strengthened glass substrates may be chemically strengthened, mechanically strengthened or thermally strengthened. In some embodiments, the strengthened glass substrate may be chemically and mechanically strengthened, mechanically and thermally strengthened, chemically and thermally strengthened or chemically, mechanically and thermally strengthened. In one or more specific embodiments, the second curved glass substrate (or the second glass substrate used to form the second curved glass substrate) is strengthened and the first curved glass substrate (or the first glass substrate used to form the first curved glass substrate) is unstrengthened but optionally annealed. One of or both of the first curved glass substrate (or the first glass substrate used to form the first curved glass substrate) and the second curved glass substrate (or the second glass substrate used to form the second curved glass substrate) may be strengthened. Where one or both of the glass substrates are chemically and/or thermally strengthened, such chemical and/or thermal strengthening may be performed on the curved glass substrate (i.e., after shaping). Such glass substrates may be optionally mechanically strengthened before shaping. Where one or both the glass substrates are mechanically strengthened (and optionally combined with one or more other strengthening methods), such mechanical strengthening may occur before shaping.

According to embodiments of the present disclosure, one of or both of the first curved glass substrate (or the first glass substrate used to form the first curved glass substrate) and the second curved glass substrate (or the second glass substrate used to form the second curved glass substrate) may be strengthened mechanically by utilizing a mismatch of the coefficient of thermal expansion between portions of the article to create a compressive stress region and a central region exhibiting a tensile stress. The DOC in such mechanically strengthened substrates is typically the thickness of the outer portions of the glass substrate having one coefficient of thermal expansion (i.e., the point at which the glass substrate coefficient of thermal expansion changes from one to another value).

According to embodiments of the present disclosure, one of or both of the first curved glass substrate (or the first glass substrate used to form the first curved glass substrate) and the second curved glass substrate (or the second glass substrate used to form the second curved glass substrate) may be strengthened thermally by heating the glass substrate to a temperature below the glass transition point and then rapidly thermally quenching, or lowering its temperature. As noted above, where one or both the glass substrates are thermally strengthened, such thermal strengthening is performed on the curved glass substrate (i.e., after shaping).

According to embodiments of the present disclosure, one of or both the first curved glass substrate (or the first glass substrate used to form the first curved glass substrate) and the second curved glass substrate (or the second glass substrate used to form the second curved glass substrate) may be chemically strengthening by ion exchange. As noted above, where one or both of the glass substrates are chemically strengthened, such chemical strengthening may be performed on the curved glass substrate (i.e., after shaping). In the ion exchange process, ions at or near the surface of the glass substrate are replaced by—or exchanged with—larger ions having the same valence or oxidation state. In those embodiments in which the glass substrate comprises a composition including at least one alkali metal oxide as measured on an oxide basis (e.g., Li₂O , Na₂O, K₂O, Rb₂O, or Cs₂O), ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass substrate generate a compressive stress on the surface portions, balanced by a tensile stress in the central portions.

Ion exchange processes are typically carried out by immersing a glass substrate in a molten salt bath (or two or more molten salt baths) containing the larger ions to be exchanged with the smaller ions in the glass substrate. It should be noted that aqueous salt baths may also be utilized. In addition, the composition of the bath(s) may include more than one type of larger ion (e.g., Na+ and K+) or a single larger ion. It will be appreciated by those skilled in the art that parameters for the ion exchange process, including, but not limited to, bath composition and temperature, immersion time, the number of immersions of the glass substrate in a salt bath (or baths), use of multiple salt baths, additional steps such as annealing, washing, and the like, are generally determined by the composition of the glass substrate (including the structure of the article and any crystalline phases present) and the desired DOC and CS of the glass substrate that results from strengthening. Exemplary molten bath composition may include nitrates, sulfates, and chlorides of the larger alkali metal ion. Typical nitrates include KNO₃, NaNO₃, LiNO₃, NaSO₄ and combinations thereof The temperature of the molten salt bath typically is in a range from about 380° C. up to about 450° C., while immersion times range from about 15 minutes up to about 100 hours depending on glass substrate thickness, bath temperature and glass (or monovalent ion) diffusivity. However, temperatures and immersion times different from those described above may also be used.

According to embodiments of the present disclosure, the glass substrate may be immersed in a molten salt bath of 100% NaNO₃, 100% KNO₃, or a combination of NaNO₃ and KNO₃ having a temperature from about 370° C. to about 480° C. For example, the glass substrate may be immersed in a molten mixed salt bath including from about 5% to about 90% KNO₃ and from about 10% to about 95% NaNO₃. Optionally, the glass substrate may be immersed in a second bath, after immersion in a first bath. The first and second baths may have different compositions and/or temperatures from one another. The immersion times in the first and second baths may vary. For example, immersion in the first bath may be longer than the immersion in the second bath.

According to embodiments of the present disclosure, the glass substrate may be immersed in a molten, mixed salt bath including NaNO₃ and KNO₃ (e.g., 49%/51%, 50%/50%, 51%/49%) having a temperature less than about 420° C. (e.g., about 400° C. or about 380° C.) for less than about 5 hours, or even about 4 hours or less.

Ion exchange conditions can be tailored to provide a “spike” or to increase the slope of the stress profile at or near the surface of the resulting glass substrate. The spike may result in a greater surface CS value. This spike can be achieved by single bath or multiple baths, with the bath(s) having a single composition or mixed composition, due to the unique properties of the glass compositions used in the glass substrates described herein.

According to embodiments of the present disclosure, where more than one monovalent ion is exchanged into the glass substrate, the different monovalent ions may exchange to different depths within the glass substrate (and generate different magnitude stresses within the glass substrate at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four-point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass substrate. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from Glasstress Ltd., located in Tallinn Estonia), depending on the strengthening method and conditions. When the glass substrate is chemically strengthened by an ion exchange treatment, FSM or SCALP may be used depending on which ion is exchanged into the glass substrate. Where the stress in the glass substrate is generated by exchanging potassium ions into the glass substrate, FSM is used to measure DOC. Where the stress is generated by exchanging sodium ions into the glass substrate, SCALP is used to measure DOC. Where the stress in the glass substrate is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass substrates is measured by FSM. Central tension or CT is the maximum tensile stress and is measured by SCALP.

According to embodiments of the present disclosure, the first curved glass substrate (or the first glass substrate used to form the first curved glass substrate) and the second curved glass substrate (or the second glass substrate used to form the second curved glass substrate) may be strengthened to exhibit a DOC that is described as a fraction of the thickness t of the glass substrate (as described herein). For example, the DOC may be equal to or greater than about 0.03 t, equal to or greater than about 0.035 t, equal to or greater than about 0.04 t, equal to or greater than about 0.045 t, equal to or greater than about 0.05 t, equal to or greater than about 0.1 t, equal to or greater than about 0.11 t, equal to or greater than about 0.12 t, equal to or greater than about 0.13 t, equal to or greater than about 0.14 t, equal to or greater than about 0.15 t, equal to or greater than about 0.16 t, equal to or greater than about 0.17 t, equal to or greater than about 0.18 t, equal to or greater than about 0.19 t, equal to or greater than about 0.2 t, equal to or greater than about 0.21t. In some embodiments, The DOC may be in a range from about 0.03 t to about 0.25 t, from about 0.04 t to about 0.25 t, from about 0.05 t to about 0.25 t, from about 0.06 t to about 0.25 t, from about 0.07 t to about 0.25 t, from about 0.08 t to about 0.25 t, from about 0.09 t to about 0.25 t, from about 0.18 t to about 0.25 t, from about 0.11 t to about 0.25 t, from about 0.12 t to about 0.25 t, from about 0.13 t to about 0.25 t, from about 0.14 t to about 0.25 t, from about 0.15 t to about 0.25 t, from about 0.08 t to about 0.24 t, from about 0.08 t to about 0.23 t, from about 0.08 t to about 0.22 t, from about 0.08 t to about 0.21 t, from about 0.08 t to about 0.2 t, from about 0.08 t to about 0.19 t, from about 0.08 t to about 0.18 t, from about 0.08 t to about 0.17 t, from about 0.08 t to about 0.16 t, or from about 0.08 t to about 0.15t. In some instances, the DOC may be about 20 μm or less. According to embodiments of the present disclosure, the DOC may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm.

According to embodiments of the present disclosure, the strengthened glass substrate may have a CS (which may be found at the surface or a depth within the glass substrate) of about 100 MPa or greater, about 150 MPa or greater, about 200 MPa or greater, about 300 MPa or greater, about 400 MPa or greater, about 500 MPa or greater, about 600 MPa or greater, about 700 MPa or greater, about 800 MPa or greater, about 900 MPa or greater, about 930 MPa or greater, about 1000 MPa or greater, or about 1050 MPa or greater.

According to embodiments of the present disclosure, the strengthened glass substrate may have a maximum tensile stress or central tension (CT) of about 20 MPa or greater, about 30 MPa or greater, about 40 MPa or greater, about 45 MPa or greater, about 50 MPa or greater, about 60 MPa or greater, about 70 MPa or greater, about 75 MPa or greater, about 80 MPa or greater, or about 85 MPa or greater. For example, the maximum tensile stress or central tension (CT) may be in a range from about 40 MPa to about 100 MPa.

According to embodiments of the present disclosure, the first curved glass substrate (or the first glass substrate used to form the first curved glass substrate) and the second curved glass substrate (or the second glass substrate used to form the second curved glass substrate) may comprise one of soda lime silicate glass, an alkali aluminosilicate glass, alkali containing borosilicate glass, alkali aluminophosphosilicate glass, or alkali aluminoborosilicate glass. One of the first curved glass substrate (or the first glass substrate used to form the first curved glass substrate) and the second curved glass substrate (or the second glass substrate used to form the second curved glass substrate) may be a soda lime silicate glass, while the other of the first curved glass substrate (or the first glass substrate used to form the first curved glass substrate) and the second curved glass substrate (or the second glass substrate used to form the second curved glass substrate) is an alkali aluminosilicate glass, alkali containing borosilicate glass, alkali aluminophosphosilicate glass, or alkali aluminoborosilicate glass.

According to embodiments of the present disclosure, the interlayer of laminates described herein (e.g., 330) may include a single layer or multiple layers. The interlayer (or layers thereof) may be formed from polymers such as polyvinyl butyral (PVB), acoustic PBV (APVB), ionomers, ethylene-vinyl acetate (EVA) and thermoplastic polyurethane (TPU), polyester (PE), polyethylene terephthalate (PET) and the like. The thickness of the interlayer may be in the range from about 0.5 mm to about 2.5 mm, from about 0.8 mm to about 2.5 mm, from about 1 mm to about 2.5 mm or from about 1.5 mm to about 2.5 mm. The interlayer may also have a non-uniform thickness, or wedge shape, from one edge to the other edge of the laminate.

According to embodiments of the present disclosure, laminates as described herein (and/or one of or both the first curved glass substrate and the second curved glass substrate) may exhibit a complexly curved shape. As used herein “complex curve” and “complexly curved” is used to mean a non-planar shape having curvature along two orthogonal axes that are different from one another. Examples of complexly curved shapes include those having simple or compound curves, also referred to as non-developable shapes, which include but are not limited to spherical, aspherical, and toroidal. The complexly curved laminates described herein may also include segments or portions of such surfaces, or may be comprised of a combination of such curves and surfaces. According to embodiments of the present disclosure, a laminate may have a compound curve including a major radius and a cross curvature. A complexly curved laminate according embodiments of the present disclosure may have a distinct radius of curvature in two independent directions. Complexly curved laminates may thus be characterized as having “cross curvature,” where the laminate is curved along an axis (i.e., a first axis) that is parallel to a given dimension and also curved along an axis (i.e., a second axis) that is perpendicular to the same dimension. The curvature of the laminate can be even more complex when a significant minimum radius is combined with a significant cross curvature, and/or depth of bend. Some laminates may also include bending along axes that are not perpendicular to one another. As a non-limiting example, the complexly-curved laminate may have length and width dimensions of about 0.5 m by about 1.0 m and a radius of curvature of about 2 to about 2.5 m along the minor axis, and a radius of curvature of about 4 to about 5 m along the major axis. The complexly-curved laminate may have a radius of curvature of about 5 m or less along at least one axis. The complexly-curved laminate may have a radius of curvature of about 5 m or less along at least a first axis and along the second axis that is perpendicular to the first axis. The complexly-curved laminate may have a radius of curvature of 5 m or less along at least a first axis and along the second axis that is not perpendicular to the first axis.

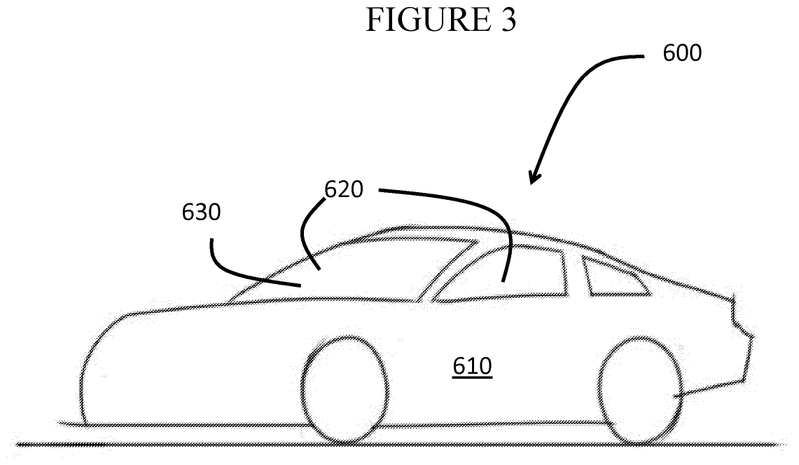

According to embodiments of the present disclosure, a vehicle is provided that includes a laminate according to one or more embodiments described herein. For example, FIG. 3 shows a vehicle 600 comprising a body 610 defining an interior, at least one opening 620 in communication with the interior, and a glazing disposed in the opening, wherein the glazing comprises a laminate 630 according to embodiments described herein. The laminate 630 of the vehicle 600 may be complexly curved. The laminate 630 may form the sidelights, windshields, rear windows, rearview mirrors, and sunroofs in the vehicle. The laminate 630 may form an interior partition (not shown) within the interior of the vehicle 600, or may be disposed on an exterior surface of the vehicle 600 and form an engine block cover, headlight cover, taillight cover, or pillar cover. The vehicle 600 may include an interior surface (not shown, but may include door trim, seat backs, door panels, dashboards, center consoles, floor boards, and pillars), and the laminate 630 or glass article described herein may be disposed on the interior surface. The interior surface may include a display and the laminate or glass article disposed over the display. As used herein, the term “vehicle” is used to refer to automobiles, motorcycles, rolling stock, locomotive, boats, ships, airplanes, helicopters, drones, space craft and the like.

According to embodiments of the present disclosure, an architectural application is provided that includes the laminates as described herein. The architectural application may be, for example, balustrades, stairs, decorative panels or covering for walls, columns, partitions, elevator cabs, household appliances, windows, furniture, and other applications, formed at least partially using a laminate or glass article according to embodiments of the present disclosure.

According to embodiments of the present disclosure, the laminate is positioned within a vehicle or architectural application such that the second curved glass substrate faces the interior of the vehicle or the interior of a building or room, such that the second curved glass substrate is adjacent to the interior (and the first curved glass substrate is adjacent the exterior). The second curved glass substrate may be in direct contact with the interior (i.e., the fourth surface 324 of the second curved glass substrate glass article facing the interior is bare and is free of any coatings). Similarly, the first surface 312 of the first curved glass substrate may be bare and free of any coatings. The laminate may be positioned within a vehicle or architectural application such that the second curved glass substrate faces the exterior of the vehicle or the exterior of a building or room, such that the second first curved glass substrate is adjacent to the exterior (and the first curved glass substrate is adjacent the interior). The second curved glass substrate of the laminate may be in direct contact with the exterior (i.e., the surface of the second curved glass substrate facing the exterior is bare and is free of any coatings).

Referring again to FIG. 1, both the first surface 312 and the fourth surface 324 may be bare and substantially free of any coatings. Optionally, one or both of the edge portions of the first surface 312 and the fourth surface 324 may include a coating while the central portions are bare and substantially free of any coatings. Optionally, one or both the first surface 312 and the fourth surface 324 may include a coating or surface treatment (e.g., antireflective coating, anti-glare coating or surface, easy-to-clean surface, ink decoration, conductive coatings etc.). The laminate may include one or more conductive coatings on one of or both of the second surface 312 or the third surface 322 adjacent the interlayer 330.

Referring again to FIG. 1A, both the first surface 322 and the fourth surface 314 may be bare and substantially free of any coatings. Optionally, one or both of the edge portions of the first surface 322 and the fourth surface 314 may include a coating while the central portions are bare and substantially free of any coatings. Optionally, one or both of the first surface 322 and the fourth surface 314 may include a coating or surface treatment (e.g., antireflective coating, anti-glare coating or surface, easy-to-clean surface, ink decoration, conductive coatings etc.). The laminate may include one or more conductive coatings on one of or both the second surface 324 or the third surface 312 adjacent the interlayer 330.

According to embodiments of the present disclosure, a method of forming a curved laminate is provided. It should be appreciated that the description of methods in the present disclosure are illustrate of embodiments of the methods described herein, that not all of the steps described need be performed, and that steps of embodiments of the methods described herein need not be performed in any particular order except where an order is specified.

The method may include forming a stack comprising a first glass substrate as described herein, and a second glass substrate as described herein, and heating the stack and co-shaping the stack to form a co-shaped stack. The second glass substrate may be disposed on the first glass substrate to form the stack. Alternatively, the first glass substrate may be disposed on the second glass substrate to form the stack.

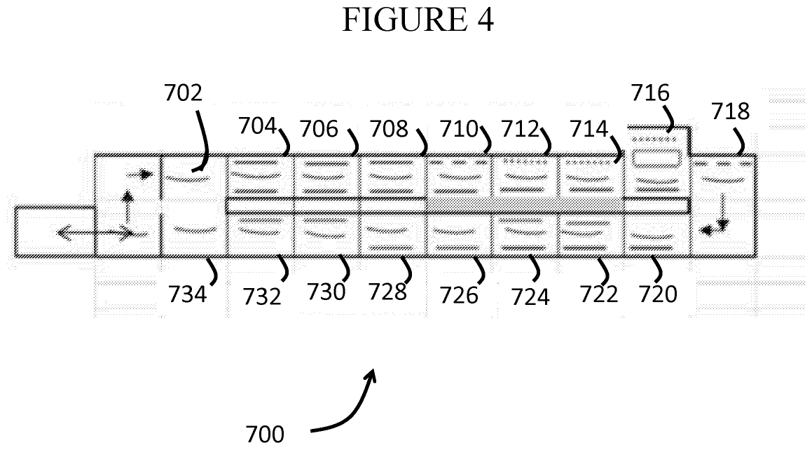

Heating the stack may include placing the stack in a dynamic furnace such as a lehr furnace or a static furnace. An example of a lehr furnace 700 is shown in FIG. 4. In a dynamic furnace such as a lehr furnace, the stack is introduced in a first module 702 and then conveyed through a series of modules 702, 704, 706, 708, 710, 712, having sequentially increasing temperatures until reaching a maximum temperature in module 714. This maximum temperature is referred to as the set point of the furnace. In module 716, the stack is co-shaped. Optionally, heat may be applied in module 716, but may not be required. The stack is then conveyed through module 718 to a series of modules 720, 722, 724, 726, 728, 730, 732 with sequentially decreasing temperature that permit gradual cooling of the stack until it reaches module 734. The duration of time for which the stack is present in each module is also specified (e.g., in a range from about 30 seconds to 500 seconds). According to embodiments of the present disclosure, module 704 may be controlled to have a temperature in a range from about 225° C. to about 275° C., module 706 may be controlled to have a temperature in a range from about 400° C. to about 460° C., module 708 may be controlled to have a temperature in a range from about 530° C. to about 590° C., module 710 may be controlled to have a temperature in a range from about 580° C. to about 640° C., module 712 may be controlled to have a temperature in a range from about 590° C. to about 650° C., and module 714 may be controlled to have a temperature in a range from about 600° C. to about 680° C. In typical furnaces, the temperature of the glass substrates is less than the temperature at which the module is controlled. For example, the difference between the glass substrate temperature and the controlled module temperature may be in a range from about 10° C. to 20° C.

The stack as described herein may comprise opposing major surfaces each comprising a central portion and an edge portion surrounding the central portion. The co-shaped stack may include a first curved glass substrate having a first sag depth and a second curved glass substrate having a second sag depth, wherein the first sag depth and the second sag depth are greater than 2 mm and within 10% of one another.

According to embodiments of the present disclosure, the first glass substrate (prior to heating and co-shaping) may include a first viscosity (poises) and a first sag temperature and the second glass substrate may include a second viscosity that is greater than or equal to 10 times the first viscosity and a second sag temperature that differs from the first sag temperature by about 30° C. or more (e.g., 35° C. or more, 40° C. or more, 45° C. or more, 50° C. or more, 55° C. or more, or 60° C. or more).

According to embodiments of the present disclosure, heating the stack may comprise heating the stack to a temperature different from the first sag temperature and the second sag temperature. Heating the stack may comprise heating the stack to a temperature between the first sag temperature and the second sag temperature (e.g., from about 630° C. to about 665° C., from about 630° C. to about 660° C., from about 630° C. to about 655° C., from about 630° C. to about 650° C., from about 630° C. to about 645° C., from about 635° C. to about 665° C., from about 640° C. to about 665° C., from about 645° C. to about 665° C., or from about 650° C. to about 665° C.). In one or more specific embodiments, heating the stack may comprise heating the stack to the first sag temperature or to the second sag temperature.

According to embodiments of the present disclosure, the first sag depth and/or the second sag depth may be in a range from about 6 mm to about 25 mm. For example, one or both of the first sag depth and the second sag depth may be in a range from about 2 mm to about 25 mm, from about 4 mm to about 25 mm, from about 5 mm to about 25 mm, from about 6 mm to about 25 mm, from about 8 mm to about 25 mm, from about 10 mm to about 25 mm, from about 12 mm to about 25 mm, from about 14 mm to about 25 mm, from about 15 mm to about 25 mm, from about 2 mm to about 24 mm, from about 2 mm to about 22 mm, from about 2 mm to about 20 mm, from about 2 mm to about 18 mm, from about 2 mm to about 16 mm, from about 2 mm to about 15 mm, from about 2 mm to about 14 mm, from about 2 mm to about 12 mm, from about 2 mm to about 10 mm, from about 2 mm to about 8 mm, from about 6 mm to about 20 mm, from about 8 mm to about 18 mm, from about 10 mm to about 15 mm, from about 12 mm to about 22 mm, from about 15 mm to about 25 mm, or from about 18 mm to about 22 mm.

According to embodiments of the present disclosure, the method may further include positioning or placing the stack on a female mold and heating the stack as it is positioned on the female mold. Co-shaping the stack may include sagging the stack using gravity through an opening in the female mold. As used herein, term such as “sag depth” refer to shaping depth achieved by sagging or other co-shaping process.

Alternatively, the method as described herein may include applying a male mold to the stack and the male mold may be applied while the stack is positioned or placed on a female mold.

According to embodiments of the present disclosure, the method may include applying a vacuum to the stack to facilitate co-shaping the stack. The vacuum may be applied while the stack is positioned or placed on a female mold.

According to embodiments of the present disclosure, the method may include heating the stack at a constant temperature while varying the duration of heating until the co-shaped stack is formed. As used herein, the term “constant temperature” means a temperature that is ±3° C. from a target temperature, ±2° C. from a target temperature, or ±1° C. from a target temperature.

According to embodiments of the present disclosure, the method may include heating the stack for a constant duration, while varying the temperature of heating until the co-shaped stack is formed. As used herein, the term “constant duration” means a duration that is ±10 seconds from a target duration, ±7 seconds from a target duration, ±5 seconds from a target duration, or ±3 seconds from a target duration.

According to embodiments of the present disclosure, the method may include co-shaping the stack by heating the stack at a constant temperature (as defined herein) during co-shaping. The method may include co-shaping the stack by heating the stack at a constantly increasing temperature during co-shaping. As used herein, the term “constantly increasing” may include a linearly increasing temperature or a temperature that increases stepwise in regular or irregular intervals.

According to embodiments of the present disclosure, the method may further include generating a temperature gradient in the stack between the central portion and the edge portion of the stack. In some instances, generating a temperature gradient may comprise applying heat unevenly to the central portion and the edge portion. More heat may be applied to the central portion than is applied to the edge portion, or more heat may be applied to the edge portion than is applied to the central portion. Generating a temperature gradient may comprise reducing the heat applied to one of the central portion and the edge portion compared to heat applied to the other of the central portion and the edge portion. In some instances, generating a temperature gradient may comprise reducing the heat applied to the central portion compared to the heat applied to the edge portion. Generating a temperature may include reducing the heat applied to the edge portion compared to the heat applied to the central portion. Heat may be reduced to the central portion or edge portion by physical means such as by shielding such portions with a physical barrier or thermal barrier or adding a heat sink to such portions.

According to embodiments of the present disclosure, the method may include generating an attractive force between the first glass substrate and the second glass substrate. Generating the attractive force may be performed while heating the stack and/or while co-shaping the stack. Generating the attractive force may include generating an electrostatic force.

According to embodiments of the present disclosure, the method may further include generating a vacuum between the first glass substrate and the second glass substrate. Generating the vacuum may be performed while heating the stack and/or while co-shaping the stack. Generating the vacuum may include heating both the stack whereby one of the first glass substrate and the second substrate (whichever is positioned below the other in the stack) begins to curve before the other of the first glass substrate and the second glass substrate. This curving of one of the first glass substrate and the second glass substrate creates a vacuum between the first glass substrate and the second glass substrate. This vacuum causes the glass substrate that does not curve first (i.e., the glass substrate that does not curve while the other glass substrate begins to sag) to begin to curve with the other glass substrate. The method may include creating and maintaining contact between the respective peripheral portions (315, 325) of the first glass substrate and the second substrate to generate and/or maintain the vacuum between the glass substrates. Such contact may be maintained along the entire peripheral portions (315, 325). According to embodiments of the present disclosure, the contact may be maintained until the sag depth is achieved in one or both of the first glass substrate and the second glass substrate.

According to embodiments of the present disclosure, the method may include forming a temporary bond between the first glass substrate and the second glass substrate. The temporary bond may include an electrostatic force or may include a vacuum force (which may be an air film between glass substrates). The method may include forming the temporary bond while heating the stack and/or while co-shaping the stack. As used herein, the phrase “temporary bond” refers to a bond that can be overcome by hand or using equipment known in the art for separating co-shaped glass substrates (which do not include an interlayer therebetween).

According to embodiments of the present disclosure, the method may further include preventing wrinkling at the peripheral portions (315, 325) of the first glass substrate and the second glass substrate. Preventing wrinkling may include shielding at least a portion or the entire peripheral portions (315, 325) of the first and second glass substrates from the heat the stack during bending.

According to embodiments of the present disclosure, the method may include placing separation powder between the first glass sheet and the second glass sheet before heating and co-shaping. In particular, the separation powder may be placed between the first and second glass sheets in such a way as to prevent bending dot defects.

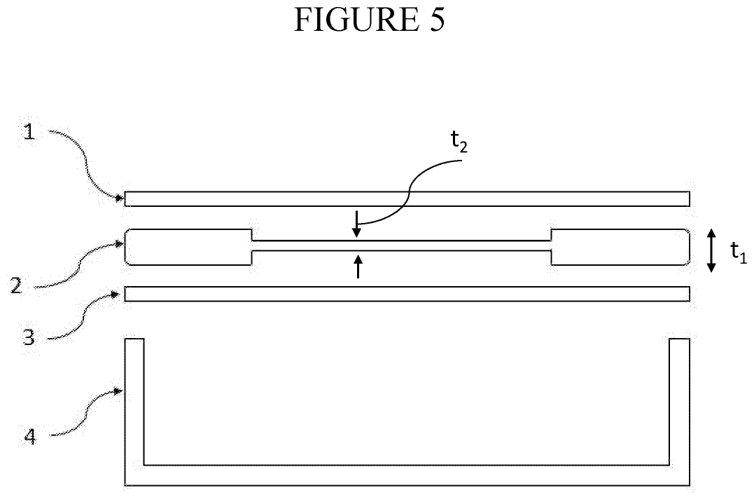

The process for producing asymmetric glass laminates or laminates of differing viscosity plies without bending dot defects is a multi-step process as described below. First, a preform may be cut from flat glass sheets of the desired thicknesses. The shape of this sheet is defined by the flat pattern needed to produce the desired shape after bending. After the preforms are cut to size, the edges may be ground to break the sharp corners and achieve a desired edge profile. After edge grinding, the preforms may then be formed. Forming may be done in a lehr furnace with zoned heating and cooling areas as previously described. The glass plies that will make up the laminate are to be pair sagged to minimize shape deviations between the plies that may lead to optical distortions or low yields during lamination. The asymmetric glass plies are to be prepared with the thin ply 1 atop of the thick ply 3 with a separation media 2 between, as shown in FIG. 5.

According to embodiments of the present disclosure, the method may further include inserting an interlayer between the first curved glass substrate and the second curved glass substrate, and laminating the first curved glass substrate, the interlayer, and the second curved glass substrate together.

Aspect (1) of this disclosure pertains to a laminate comprising: a first curved glass substrate comprising a first major surface, a second major surface opposing the first major surface, a first thickness (h₁) defined as the distance between the first major surface and second major surface, and a first viscosity (η₁) of 1×10¹¹ poises at a first temperature (T1); a second curved glass substrate comprising a third major surface, a fourth major surface opposing the third major surface, a second thickness (h₂) defined as the distance between the third major surface and the fourth major surface, the second thickness being less than the first thickness, and a second viscosity (η₂) at the first temperature (T1); and an interlayer disposed between the first curved glass substrate and the second curved glass substrate and adjacent the second major surface and third major surface, wherein the first curved glass substrate, the second curved glass substrate and the interlayer comprise a co-shaped stack, wherein the ratio of the first thickness to the second thickness (h₁/h₂) is greater than about 2.1, and wherein the value of the ratio of the second viscosity to the first viscosity (η₂/η₁) is between about (h₁/h₂)^{2.55} and about (h₁/h₂)³.

Aspect (2) of this disclosure pertains to the laminate of Aspect (1), wherein the value of the ratio of the second viscosity to the first viscosity (η₂/η₁) is between about (h₁/h₂)^{2.62} and about (h₁/h₂)^{3.38}.

Aspect (3) of this disclosure pertains to the laminate of Aspect (1) or Aspect (2) wherein the value of the ratio of the second viscosity to the first viscosity (η₂/η₁) is between about (h₁/h₂)^{2.73} and about (h₁/h₂)^{3.27}.

Aspect (4) of this disclosure pertains to the laminate of any one of Aspects (1) through (3), wherein the first sag depth is within 10% of the second sag depth and wherein the laminate comprises a shape deviation between the first glass substrate and the second glass substrate of ±5 mm or less as measured by an optical three-dimensional scanner.

Aspect (5) of this disclosure pertains to the laminate of any one of Aspects (1) through (4), The laminate of any one of the preceding claims, wherein the shape deviation is about ±1 mm or less.

Aspect (6) of this disclosure pertains to the laminate of any one of Aspects (1) through (5), wherein the shape deviation is about ±0.5 mm or less.

Aspect (7) of this disclosure pertains to the laminate of any one of Aspects (1) through (6), wherein the second viscosity is in a range from about 10 times the first viscosity to about 750 times the first viscosity.

Aspect (8) of this disclosure pertains to the laminate of any one of Aspects (1) through (7), wherein the first thickness is from about 1.6 mm to about 3.5 mm, and the second thickness is from about 0.1 mm to less than about 1.6 mm.

Aspect (9) of this disclosure pertains to the laminate of any one of Aspects (1) through (8), wherein the first curved substrate comprises a first sag temperature and the second curved glass substrate comprises a second sag temperature that differs from the first sag temperature.

Aspect (10) of this disclosure pertains to the laminate of Aspect (9), wherein the difference between the first sag temperature and the second sag temperature is from about 5° C. to about 150° C.

Aspect (11) of this disclosure pertains to the laminate of any one of Aspects (1) through (10), further comprising an optical distortion of about 100 millidiopters or less.

Aspect (12) of this disclosure pertains to the laminate of any one of Aspects (1) through (11), further comprising a membrane tensile stress of about 5 MPa or less.

Aspect (13) of this disclosure pertains to the laminate of any one of Aspects (1) through (12), wherein the second sag depth is in a range from about 5 mm to about 30 mm.

Aspect (14) of this disclosure pertains to the laminate of any one of Aspects (1) through (13), wherein the first major surface or the second major surface comprises a surface compressive stress of less than 3 MPa as measured by a surface stress meter.

Aspect (15) of this disclosure pertains to the laminate of any one of Aspects (1) through (14), wherein the laminate is substantially free of visual distortion as measured by ASTM C1652/C1652M.

Aspect (16) of this disclosure pertains to the laminate of any one of Aspects (1) through (15), wherein the second curved glass substrate is strengthened.

Aspect (17) of this disclosure pertains to the laminate of Aspect (16), wherein the second curved glass substrate is chemically strengthened, mechanically strengthened or thermally strengthened.

Aspect (18) of this disclosure pertains to the laminate of Aspect (16) or Aspect (17), wherein the first glass curved substrate is unstrengthened.

Aspect (19) of this disclosure pertains to the laminate of any one of Aspects (16) through (18), wherein the first curved glass substrate is strengthened.

Aspect (20) of this disclosure pertains to the laminate of any one of Aspects (1) through (19), wherein the first curved glass substrate comprises a soda lime silicate glass.

Aspect (21) of this disclosure pertains to the laminate of any one of Aspects (1) through (20), wherein the first curved glass substrate comprises an alkali aluminosilicate glass, alkali containing borosilicate glass, alkali aluminophosphosilicate glass, or alkali aluminoborosilicate glass.

Aspect (22) of this disclosure pertains to the laminate of any one of Aspects (1) through (21), where the laminate is complexly curved.

Aspect (23) of this disclosure pertains to the laminate of any one of Aspects (1) through (22), wherein the laminate comprises automotive glazing or architectural glazing.

Aspect (24) pertains to a vehicle comprising: a body defining an interior and an opening in communication with the interior; and a laminate according to any one of Aspects (1) through (23) disposed in the opening.

Aspect (25) pertains to a method of forming a curved laminate comprising: disposing separation media on a second major surface of a first glass substrate, the separation media being disposed in a predetermined pattern; forming a stack comprising the first glass substrate and a second glass substrate with the separation media disposed therebetween; and heating the stack and co-shaping the stack to form a co-shaped stack, the co-shaped stack comprising a first curved glass substrate having a first sag depth and a second curved glass substrate having a second sag depth, wherein the first glass substrate comprises a first major surface opposing the second major surface, a first thickness defined as the distance between the first major surface and second major surface, and a first viscosity (η₁) of 1×10¹¹ poises at a first temperature (T1), wherein the second glass substrate comprises a third major surface, a fourth major surface opposing the third major surface, a second thickness defined as the distance between the third major surface and the fourth major surface, the second thickness being less than the first thickness, and a second viscosity (η₂) at the first temperature (T1), wherein the ratio of the first viscosity to the second viscosity is approximately the cube of the ratio of the first thickness to the second thickness, wherein the ratio of the first thickness to the second thickness (h₁/h₂) is greater than about 2.1, and wherein the ratio of the second viscosity to the first viscosity (η₁/η₂) is between about (h₁/h₂)^{2 55} and about (h₁/h₂)^{3.45}.

Aspect (26) pertain to the method of Aspect (25), wherein the value of the ratio of the second viscosity to the first viscosity (η₂/η₁) is between about (h₁/h₂)^{2.62} and about (h₁/h₂)^{3.38}.

Aspect (27) pertain to the method of Aspect (25) or Aspect (26), wherein the value of the ratio of the second viscosity to the first viscosity (η₂/η₁) is between about (h₁/h₂)^{2 73} and about (h₁/h₂)^{3.27}.

Aspect (28) pertain to the method of any one of Aspects (25) through (27), wherein the first sag depth and the second sag depth are greater than 2 mm and within 10% of one another.

Aspect (29) pertain to the method of any one of Aspects (25) through (28), wherein heating the stack comprises heating the stack to a temperature different from the first sag temperature and the second sag temperature.

Aspect (30) pertain to the method of any one of Aspects (25) through (29), wherein heating the stack comprises heating the stack to a temperature between the first sag temperature and the second sag temperature.

Aspect (31) pertain to the method of any one of Aspects (25) through (28), wherein heating the stack comprises heating the stack to the first sag temperature.

Aspect (32) pertain to the method of any one of Aspects (25) through (28), wherein heating the stack comprises heating the stack to the second sag temperature.

Aspect (33) pertain to the method of any one of Aspects (25) through (32), wherein the first sag depth or the second sag depth is in a range from about 6 mm to about 30 mm.

Aspect (34) pertain to the method of any one of Aspects (25) through (33), further comprising placing the stack on a female mold and heating the stack on the female mold.

Aspect (35) pertain to the method of Aspect (34), wherein co-shaping the stack comprises sagging the stack using gravity through an opening in the female mold.

Aspect (36) pertain to the method of Aspect (34) or Aspect (35), further comprising applying a male mold to the stack.

Aspect (37) pertain to the method of any one of Aspects (25) through (36), further comprising applying a vacuum to the stack to facilitate co-shaping the stack.

While the present disclosure includes a limited number of embodiments, those skilled in the art, having benefit of this disclosure, will appreciate that other embodiments can be devised which do not depart from the scope of the present disclosure.

1. A laminate comprising:
a first curved glass substrate comprising a first major surface, a second major surface opposing the first major surface, a first thickness (h₁) defined as the distance between the first major surface and second major surface, and a first viscosity (η₁) of 1×10¹¹ poises at a first temperature (T1);
a second curved glass substrate comprising a third major surface, a fourth major surface opposing the third major surface, a second thickness (h₂) defined as the distance between the third major surface and the fourth major surface, the second thickness being less than the first thickness, and a second viscosity (η₂) at the first temperature (T1); and
an interlayer disposed between the first curved glass substrate and the second curved glass substrate and adjacent the second major surface and third major surface,
wherein the first curved glass substrate, the second curved glass substrate and the interlayer comprise a co-shaped stack,
wherein the ratio of the first thickness to the second thickness (h₁/h₂) is greater than about 2.1, and
wherein the value of the ratio of the second viscosity to the first viscosity (η₂/η₁) is between about (h₁/h₂)^{2.55} and about (h₁/h₂)^{3.45}.

2. The laminate of claim 1, wherein the value of the ratio of the second viscosity to the first viscosity (η₂/η₁) is between about (h₁/h₂)^{2.62} and about (h₁/h₂)^{3.38}.

3. The laminate of claim 1, wherein the value of the ratio of the second viscosity to the first viscosity (η₂/η₁) is between about (h₁/h₂)^{2 73} and about (h₁/h₂)^{3.27}.

4. The laminate of claim 1, wherein a first sag depth of the first curved glass substrate is within 10% of a second sag depth of the second curved glass substrate and wherein the laminate comprises a shape deviation between the first glass substrate and the second glass substrate of ±5 mm or less as measured by an optical three-dimensional scanner.

5. (canceled)

6. The laminate of claim 1, wherein the shape deviation is about ±0.5 mm or less.

7. The laminate of claim 1, wherein the second viscosity is in a range from about 10 times the first viscosity to about 750 times the first viscosity.

8. The laminate of claim 1, wherein the first thickness is from about 1.6 mm to about 3.5 mm, and the second thickness is from about 0.1 mm to less than about 1.6 mm.

9. The laminate of claim 1, wherein the first curved substrate comprises a first sag temperature and the second curved glass substrate comprises a second sag temperature that differs from the first sag temperature.

10. The laminate of claim 9, wherein the difference between the first sag temperature and the second sag temperature is from about 5° C. to about 150° C.

11. The laminate of claim 1 further comprising an optical distortion of about 100 millidiopters or less.

12. The laminate of claim 1 further comprising a membrane tensile stress of about 5 MPa or less.

13. The laminate of claim 1, wherein a second sag depth of the second curved glass substrate is in a range from about 5 mm to about 30 mm.

14. (canceled)

15. The laminate of claim 1, wherein the laminate is substantially free of visual distortion as measured by ASTM C1652/C1652M.

16. (canceled)

17. (canceled)

18. (canceled)

19. (canceled)

20. The laminate of claim 1, wherein the first curved glass substrate comprises a soda lime silicate glass, an alkali aluminosilicate glass, alkali containing borosilicate glass, alkali aluminophosphosilicate glass, or alkali aluminoborosilicate glass.

21. (canceled)

22. (canceled)

23. (canceled)

24. (canceled)

25. A method of forming a curved laminate comprising:
disposing separation media on a second major surface of a first glass substrate, the separation media being disposed in a predetermined pattern;
forming a stack comprising the first glass substrate and a second glass substrate with the separation media disposed therebetween; and
heating the stack and co-shaping the stack to form a co-shaped stack, the co-shaped stack comprising a first curved glass substrate having a first sag depth and a second curved glass substrate having a second sag depth,
wherein the first glass substrate comprises a first major surface opposing the second major surface, a first thickness defined as the distance between the first major surface and second major surface, and a first viscosity (η₁) of 1×10¹¹ poises at a first temperature (T1),
wherein the second glass substrate comprises a third major surface, a fourth major surface opposing the third major surface, a second thickness defined as the distance between the third major surface and the fourth major surface, the second thickness being less than the first thickness, and a second viscosity (η₂) at the first temperature (T1),
wherein the ratio of the first viscosity to the second viscosity is approximately the cube of the ratio of the first thickness to the second thickness,
wherein the ratio of the first thickness to the second thickness (h₁/h₂) is greater than about 2.1, and
wherein the ratio of the second viscosity to the first viscosity (η₂/η₁) is between about (h₁/h₂)^{2.55} and about (h₁/h₂)^{3.45}.

26. (canceled)

27. The method of claim 25, wherein the value of the ratio of the second viscosity to the first viscosity (η₁/η₂) is between about (h₁/h₂)^{2.73} and about (h₁/h₂)^{3.27}.

28. (canceled)

29. (canceled)

30. The method of claim 25, wherein heating the stack comprises heating the stack to a temperature between the first sag temperature and the second sag temperature.

31. The method of claim 25, wherein heating the stack comprises heating the stack to the first sag temperature or the second sag temperature.

32. (canceled)

33. (canceled)

34. The method of claim 25, further comprising placing the stack on a female mold and heating the stack on the female mold,. wherein co-shaping the stack comprises sagging the stack using gravity through an opening in the female mold or applying a male mold to the stack.

35. (canceled)

36. (canceled)

37. The method of claim 25, further comprising applying a vacuum to the stack to facilitate co-shaping the stack.
